(19) United States
(12) Patent Application Publication
(10) Pub. No.: US 2026/0158725 A1
(43) Pub. Date: Jun. 11, 2026

(54) CONTAINER FORMULATION AND LAYER STRUCTURE

(71) Applicant: BERRY GLOBAL, INC., Evansville, IN (US)

(72) Inventors: Ryan DEWIG, Evansville, IN (US); Roy E. ACKERMAN, Evansville, IN (US); Kaitlyn HOWARD, Lawrence, KS (US); Lucas HOBSON, Evansville, IN (US); Xenia ADAMES CHANIS, Evansville, IN (US)

(21) Appl. No.: 19/409,122

(22) Filed: Dec. 4, 2025

Related U.S. Application Data
(60) Provisional application No. 63/728,446, filed on Dec. 5, 2024.

(51) Int. Cl. B29C 48/00; B29C 48/07; B29C 48/21; B29C 48/91; B29K 23/00; B29K 105/04; B29L 7/00; B29L 9/00; B65D 1/26; C08K 5/00

(52) U.S. Cl. CPC B29C 48/022; B29C 48/0012; B29C 48/07; B29C 48/21; B29C 48/91; B65D 1/265; C08K 5/0083; B29K 2023/12; B29K 2023/14; B29K 2105/041; B29K 2995/0018; B29K 2995/0064; B29K 2995/0097; B29L 2007/002; B29L 2009/00

(57) ABSTRACT

The present disclosure is directed to sheets comprising one or more layers. The sheet comprises a foamed layer comprising a first formulation, and a first non-foamed layer, positioned adjacent to a first surface of the foamed layer, comprising a second formulation including a beta nucleating agent.

### PRIORITY CLAIM

This application claims priority under 35 U.S.C. § 119(e) to U.S. Provisional Patent Application No. 63/728,446, filed Dec. 5, 2024, which is expressly incorporated by reference herein.

### BACKGROUND

The present disclosure relates to polymer formulations, and particularly to a sheet made of the polymer formulations. More particularly, the present disclosure relates to products made of the thermoformed sheets and multilayer films.

### SUMMARY

According to the present disclosure, a polymer formulation to make sheets by extrusion includes a polymer and at least one additive as disclosed herein. In another aspect, the present disclosure provides a multilayer sheet made by extruding the polymer formulation as disclosed herein. In another aspect, the present disclosure provides for a food container comprising a multilayer sheet as disclosed herein.

In one illustrative embodiment, the present disclosure provides a polymer formulation comprising beta nucleating agents. In one illustrative embodiment, the present disclosure provides a multilayer sheet including a first layer that is a foamed layer and one or more non-foamed layers. In some embodiments, the non-foamed layers are comprised of the same polymer formulation. In other embodiments, the non-foamed layers are comprised of different polymer formulations.

Additional features of the present disclosure will become apparent to those skilled in the art upon consideration of illustrative embodiments exemplifying the best mode of carrying out the disclosure as presently perceived.

### BRIEF DESCRIPTIONS OF THE DRAWINGS

The detailed description particularly refers to the accompanying figures in which:

FIG. 1 is a perspective view of a container formed of a multilayer polymer sheet in accordance with the present disclosure with portions broken away to reveal each layer in the multilayer polymer sheet;

FIG. 2 is an enlarged portion of FIG. 1 showing the multilayer polymer sheet includes, from left to right, a first non-foamed layer, a foamed layer, and a second foamed layer;

FIG. 3A illustrates the melting curves for polypropylene with α-crystals;

FIG. 3B illustrates the melting curves for polypropylene with α-crystals and β-crystals;

FIG. 4A is a diagrammatic view of a three-layered sheet in accordance with the present disclosure showing that at least two layers comprise the same polymer formulation;

FIG. 4B is a diagrammatic view of a three-layered sheet in accordance with the present disclosure showing that each layer comprises a different polymer formulation;

FIG. 4C is a diagrammatic view of a two-layered sheet in accordance with the present disclosure showing that each layer comprises a different polymer formulation;

FIG. 4D is a diagrammatic view of a two-layered sheet in accordance with the present disclosure showing that each layer comprises a different polymer formulation;

FIG. 4E is a diagrammatic view of one embodiment of a multi-layered sheet in accordance with the present disclosure showing that the multi-layered sheet may include any number (n) of suitable layers;

FIG. 4F is a diagrammatic view of one embodiment of a single layered sheet in accordance with the present disclosure;

FIG. 5A is a perspective view of the drinking cup of FIG. 1;

FIG. 5B is a perspective view of a food container in accordance with the present disclosure;

FIG. 5C is a perspective view of a yogurt container in accordance with the present disclosure;

FIG. 5D is a perspective view of a container with an in-mold label in accordance with the present disclosure;

FIGS. 6A-6C are a series of views showing the different locations along the sidewalls and base of an exemplary container used to measure thickness;

FIG. 6D shows the thickness across the identified locations for containers made with different polymer formulations;

FIGS. 7A-7F are a series of views showing the gram weight at the time of running the production for the various target weights;

FIGS. 8A-8B are a series of views showing the gram weight 48 hours after the production for the various target weights;

FIGS. 9A-9F are a series of views showing the gram weight 7 days after the production for the various target weights;

FIGS. 10A-10D are a series of views showing the rigidity at the time of running the production for the various target weights;

FIGS. 11A-11F are a series of views showing the rigidity 48 hours after the production for the various target weights;

FIGS. 12A-12F are a series of views showing the rigidity 7 days after the production for the various target weights;

FIG. 13A illustrates the cell count in polymer sheets made with the polymer formulations in accordance with the present disclosure; and

FIG. 13B illustrates the cell count in comparative polymer sheets.

### DETAILED DESCRIPTION

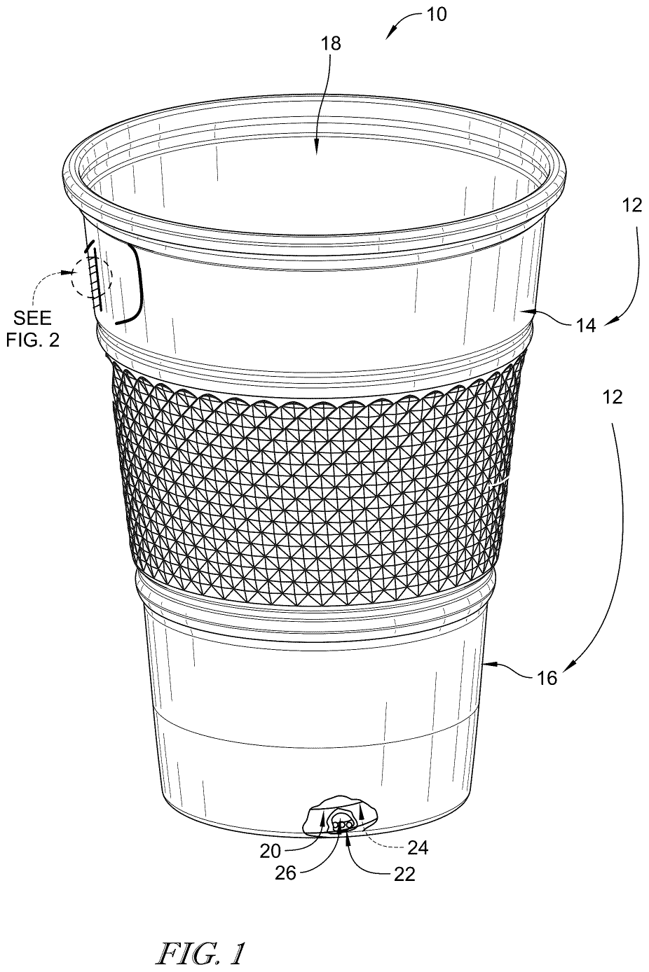

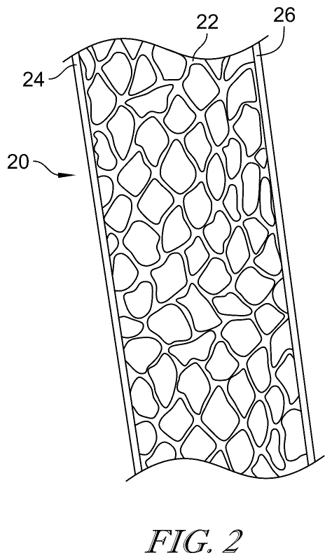

A container 10 in accordance with the present disclosure is formed of a multilayer sheet 20 as shown in FIGS. 1 and 2. The multilayer sheet 20 comprises a central foam layer 22 and two skin layers 24, 26 as shown in FIG. 2. The multilayer sheet 20 provides the container 10 with advantageous properties such as improved rigidity which allows for reduced density providing better mechanical properties. The container 10 includes a body 12 having a side wall 14 and a floor 16. The floor 16 is coupled to body 12 and cooperates with side wall 14 to form an interior region 18 therebetween for storing food, liquid, or any suitable product.

### Polymer Formulation

One aspect of the present disclosure provides a polymer formulation for manufacturing the multilayer sheet 20. In one illustrative embodiment, the multilayer sheet 20 is a multilayer thermoformed sheet 20 as disclosed herein. In some embodiments, each layer of the multilayer sheet 20 may comprise a different polymer formulation. In some embodiments, more than one layer of the multilayer sheet 20 may comprise the same polymer formulation.

In one embodiment, the present disclosure is directed to a polymer formulation. In one embodiment, the polymer formulation disclosed herein comprises one or more polymers and one or more additives. In some embodiments, the polymer may be a polyolefin, a hydrocarbon, or a combination thereof. In one example, the polymer may be polypropylene. In some embodiments, the polymer may be any suitable polyethylene. In another example, the polymer may include low density polyethylene (LDPE), linear low density polyethylene (LLDPE), medium density polyethylene (MDPE), high density polyethylene (HDPE), polyethylene copolymer (e.g., ethylene-vinyl acetate (EVA), ethylene-methyl acrylate (EMA), ethylene-acrylic acid (EAA), and ethylene-vinyl alcohol (EVOH)), polyolefin plastomer (POP), polyolefin elastomer (POE) (e.g., olefin block copolymer (OBC)), or any combination thereof. In some embodiments, the polymer may include a blend of different resins.

In some embodiments, the polymer formulation may include SC204 (LyndonBassell), 6023N (Braskem), or 6025 (Braskem). In some embodiments, the polymer formulation may further include a high melt strength polymer such as WB140 (Daploy). In some embodiments, the polymer formulation may include 0% to about 30% of a high melt strength polymer, including any percentage or range comprised therein. In some embodiments, the polymer formulation may include about 1%, about 2%, about 3%, about 4%, about 5%, about 6%, about 7%, about 8%, about 9%, about 10%, about 11%, about 12%, about 13%, about 14%, about 15%, about 16%, about 17%, about 18%, about 19%, about 20%, about 21%, about 22%, about 23%, about 24%, about 25%, about 26%, about 27%, about 28%, about 29%, or about 30% of a high melt strength polymer.

In some embodiments, the additive may be a nucleating or crystalizing agent. In some embodiments, the additive may be a beta nucleating agent. A beta nucleating agent encourages the development of the β-crystal phase in the polymer. β-crystals have a trigonal cell structure compared to a monoclinic cell structure of α-crystals. In one embodiment, the additive is MPM-2000 (Mayzo Specialty Chemicals Plus of South Carolina, USA. In some embodiments, an additive may be a colorant. In some embodiments, an additive may be an antioxidant. In some embodiments, an additive may be used to improve foaming quality. In some embodiments, the additive may be sodium bicarbonate.

In some embodiments, the polymer formulation may include about 0.1 wt % to about 20 wt % of an additive, including any suitable percentage or range comprised therein. In some embodiments, the polymer formulation may include about 0.1 wt % to about 0.5 wt %, about 0.5 wt % to about 1 wt %, about 1 wt % to about 5 wt %, about 5 wt % to about 10 wt %, about 10 wt % to about 15 wt %, or about 15 wt % to about 20 wt % of the additive. In some embodiments, the polymer formulation may include about 0.5 wt % to about 20 wt % of a nucleating agent, including any percentage or range comprised therein. In some embodiments, the polymer formulation may include about 0.5 wt % to about 1 wt %, about 1 wt % to about 5 wt %, about 5 wt % to about 10 wt %, about 10 wt % to about 15 wt %, or about 15 wt % to about 20 wt % of the nucleating agent. In some embodiments, the polymer formulation may include about 0.1 wt % to about 0.5 wt %, 0.5 wt % to about 20 wt % of a beta nucleating agent, including any percentage or range comprised therein. In some embodiments, the polymer formulation may include about 0.5 wt % to about 1 wt %, about 1 wt % to about 5 wt %, about 5 wt % to about 10 wt %, about 10 wt % to about 15 wt %, or about 15 wt % to about 20 wt % of the beta nucleating agent. In some embodiments, the polymer formulation may include about 0.5 wt % to about 20 wt % of a colorant, including any percentage or range comprised therein. In some embodiments, the polymer formulation may include about 0.1 wt % to about 0.5 wt %, about 0.5 wt % to about 1 wt %, about 1 wt % to about 5 wt %, about 5 wt % to about 10 wt %, about 10 wt % to about 15 wt %, or about 15 wt % to about 20 wt % of the colorant.

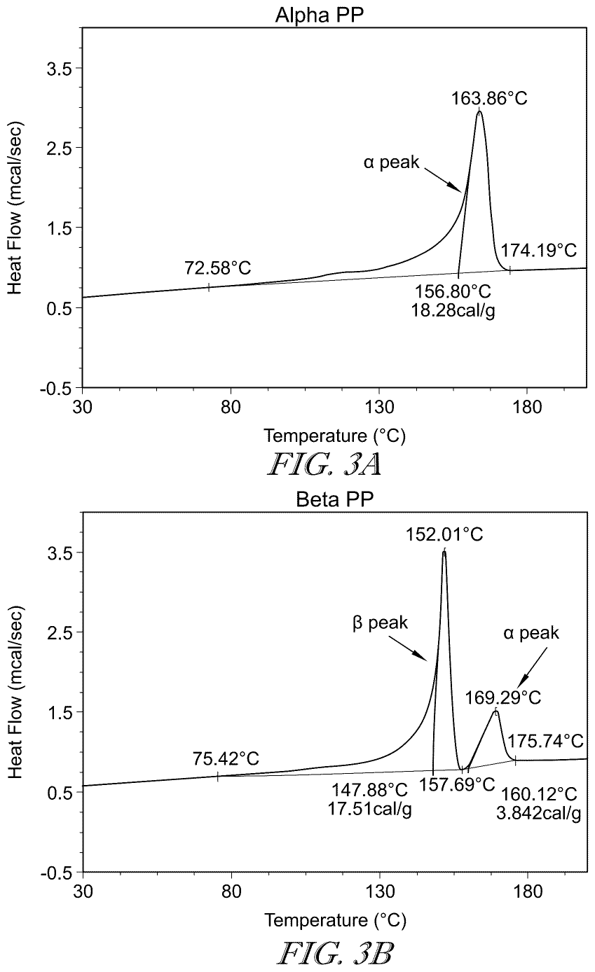

In some embodiments, the polymer formulation may comprise polypropylene and a beta nucleating agent. The melting temperature of polypropylene with β-crystals formed by the use of a beta nucleating agent is about 150° C. compared to a temperature or about 164° C. of polypropylene with α-crystals only (see FIGS. 3A-3B). FIG. 3A illustrates the melting curves for polypropylene with α-crystals. FIG. 3B illustrates the melting curves for polypropylene with α-crystals and with β-crystals.

In some embodiments, the polymer formulation may include about 5 wt % to about 99 wt % of the polymer, including any suitable percentage or range comprised therein. In some embodiments, the polymer formulation may include about 5 wt % to about 10 wt %, about 10 wt % to about 15 wt %, about 15 wt % to about 20 wt %, about 20 wt % to about 25 wt %, about 25 wt % to about 30 wt %, about 30 wt % to about 35 wt %, about 35 wt % to about 40 wt %, about 40 wt % to about 45 wt %, about 45 wt % to about 50 wt %, about 50 wt % to about 55 wt %, about 55 wt % to about 60 wt %, about 60 wt % to about 65 wt %, about 65 wt % to about 70 wt %, about 70 wt % to about 75 wt %, about 75 wt % to about 80 wt %, about 80 wt % to about 85 wt %, about 85 wt % to about 90 wt %, about 90 wt % to about 95 wt %, or about 95 wt % to about 99 wt % of the polymer. It is within the present disclosure for the weight percent of the polymer of the polymer formulation to fall within one of the following ranges: greater than about 5 wt %, greater than about 40 wt %, greater than about 80 wt %, less than about 40 wt %, less than about 80 wt %, or less than about 99 wt %.

In some embodiments, the polymer formulation may include about 5 wt % to about 99 wt % of regrind, including any suitable percentage or range comprised therein. Regrind, for example, is material that is ground into smaller pieces and reused in the formulation. The material used to form regrind may come from webbing formed from the mold around the sheet, sheets or portions of sheets that may not be used in the thermoforming process, and thermoformed containers made from the sheet.

In some embodiments, the regrind may be a hot regrind that is used immediately after formation. In some embodiments, the regrind may be a cold regrind that is used some time after formation.

In some embodiments, the polymer formulation may include about 5 wt % to about 10 wt %, about 10 wt % to about 15 wt %, about 15 wt % to about 20 wt %, about 20 wt % to about 25 wt %, about 25 wt % to about 30 wt %, about 30 wt % to about 35 wt %, about 35 wt % to about 40 wt %, about 40 wt % to about 45 wt %, about 45 wt % to about 50 wt %, about 50 wt % to about 55 wt %, about 55 wt % to about 60 wt %, about 60 wt % to about 65 wt %, about 65 wt % to about 70 wt %, about 70 wt % to about 75 wt %, about 75 wt % to about 80 wt %, about 80 wt % to about 85 wt %, about 85 wt % to about 90 wt %, about 90 wt % to about 95 wt %, or about 95 wt % to about 99 wt % of the regrind. It is within the present disclosure for the weight percent of the regrind of the polymer formulation to fall within one of the following ranges: greater than about 5 wt %, greater than about 40 wt %, greater than about 80 wt %, less than about 40 wt %, less than about 80 wt %, or less than about 99 wt %.

In some embodiments, the polymer formulation may include a first polymer and a second polymer. In some embodiments, the polymer formulation may include a first polymer, a second polymer, and third polymer. In some embodiments, the second or third polymer may be a high melt strength polymer. In some embodiments, the polymer formulation may include more than three polymers.

In some embodiments, the polymer formulation may include about 1% to about 5%, about 5 wt % to about 10 wt %, about 10 wt % to about 15 wt %, about 15 wt % to about 20 wt %, about 20 wt % to about 25 wt %, about 25 wt % to about 30 wt %, about 30 wt % to about 35 wt %, about 35 wt % to about 40 wt %, about 40 wt % to about 45 wt %, about 45 wt % to about 50 wt %, about 50 wt % to about 55 wt %, about 55 wt % to about 60 wt %, about 60 wt % to about 65 wt %, about 65 wt % to about 70 wt %, about 70 wt % to about 75 wt %, about 75 wt % to about 80 wt %, about 80 wt % to about 85 wt %, about 85 wt % to about 90 wt %, about 90 wt % to about 95 wt %, or about 95 wt % to about 99 wt % of the first polymer. It is within the present disclosure for the weight percent of the first polymer of the polymer formulation to fall within one of the following ranges: greater than about 1 wt %, greater than about 5 wt %, greater than about 40 wt %, greater than about 80 wt %, less than about 40 wt %, less than about 80 wt %, or less than about 99 wt %.

In some embodiments, the polymer formulation may include about 1% to about 5%, about 5 wt % to about 10 wt %, about 10 wt % to about 15 wt %, about 15 wt % to about 20 wt %, about 20 wt % to about 25 wt %, about 25 wt % to about 30 wt %, about 30 wt % to about 35 wt %, about 35 wt % to about 40 wt %, about 40 wt % to about 45 wt %, about 45 wt % to about 50 wt %, about 50 wt % to about 55 wt %, about 55 wt % to about 60 wt %, about 60 wt % to about 65 wt %, about 65 wt % to about 70 wt %, about 70 wt % to about 75 wt %, about 75 wt % to about 80 wt %, about 80 wt % to about 85 wt %, about 85 wt % to about 90 wt %, about 90 wt % to about 95 wt %, or about 95 wt % to about 99 wt % of the second polymer. It is within the present disclosure for the weight percent of the second polymer of the polymer formulation to fall within one of the following ranges: greater than about 1 wt %, greater than about 5 wt %, greater than about 40 wt %, greater than about 80 wt %, less than about 40 wt %, less than about 80 wt %, or less than about 99 wt %.

In some embodiments, the polymer formulation may include about 1% to about 5%, about 5 wt % to about 10 wt %, about 10 wt % to about 15 wt %, about 15 wt % to about 20 wt %, about 20 wt % to about 25 wt %, about 25 wt % to about 30 wt %, about 30 wt % to about 35 wt %, about 35 wt % to about 40 wt %, about 40 wt % to about 45 wt %, about 45 wt % to about 50 wt %, about 50 wt % to about 55 wt %, about 55 wt % to about 60 wt %, about 60 wt % to about 65 wt %, about 65 wt % to about 70 wt %, about 70 wt % to about 75 wt %, about 75 wt % to about 80 wt %, about 80 wt % to about 85 wt %, about 85 wt % to about 90 wt %, about 90 wt % to about 95 wt %, or about 95 wt % to about 99 wt % of the third polymer. It is within the present disclosure for the weight percent of the third polymer of the polymer formulation to fall within one of the following ranges: greater than about 1 wt %, greater than about 5 wt %, greater than about 40 wt %, greater than about 80 wt %, less than about 40 wt %, less than about 80 wt %, or less than about 99 wt %.

### Polymer Sheet

In another aspect, the present disclosure is directed to a polymer sheet formed by tandem extrusion or a mixer. In some embodiments, the polymer sheet maybe formed into a thermoformed including a container. The process of thermoforming improves impact strength of the polymer sheet, lowers tensile yield strength of the polymer sheet, and/or increases drawability of the polymer sheet. The process of thermoforming improves thickness distribution and/or rigidity of the polymer sheet. Containers made from thermoformed sheets may be lighter in weight without losing product strength.

In some embodiments, the polymer sheet may be formed by any suitable extrusion process such as extrusion or co-extrusion. In some embodiments, the extrusion process may include a physical blowing agent. For example, the physical blowing agent may be a gas such as carbon dioxide or nitrogen. In some embodiments, the extrusion process may include a chemical blowing agent. In some embodiments, the extrusion process may not include either a physical or chemical blowing agent.

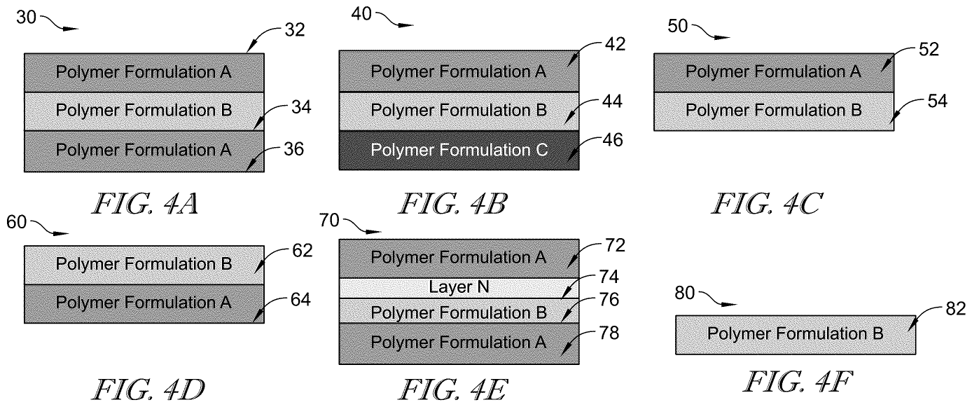

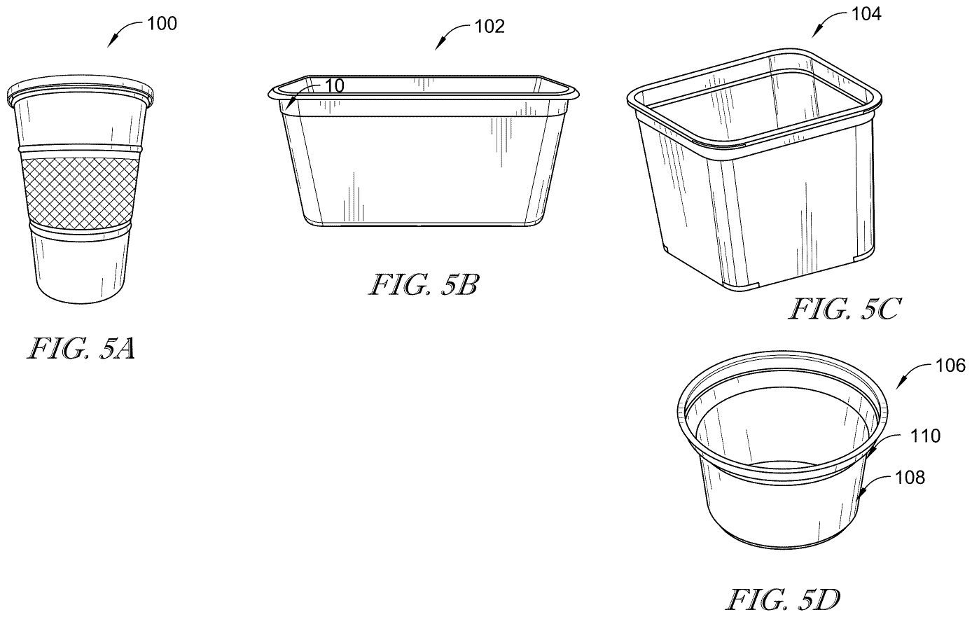

In some embodiments, the polymer sheet may be a multilayer sheet as shown in FIG. 4A-4F. In some embodiments, the multilayer sheet may comprise two layers. In other embodiments, the multilayer sheet may comprise more than two layers. For example, the multilayer sheet may comprise ten or fewer layers. In some embodiments, the multilayer sheets may comprise two to three, three to five, five to eight, or eight to ten layers. In some embodiments, all layers of the multilayer sheet may comprise the same polymer formulation. In other embodiments, the multilayer sheet may comprise layers of at least two different polymer formulations. In yet other embodiments, each layer of the multilayer sheet may comprise a different polymer formulation.

In some embodiments, the multilayer sheet may comprise any suitable number of co-extruded layers. In some embodiments, the multilayer sheet may comprise two, three, four, five, six, seven, eight, or nine co-extruded layers. In some embodiments, at least one layer of the multilayer sheet may be made by an extrusion process that includes a blowing agent. In some embodiments, all layers of the multilayer sheet may be made by an extrusion process that includes a physical blowing agent. In some embodiments, all layers of the multilayer sheet may be made by an extrusion process that includes a chemical blowing agent. In some embodiment, at least one layer of the multilayer sheet may be made by an extrusion process that does not include a blowing agent.

In some embodiments, each layer of the multilayer sheet may be formed by extruding at least one polymer formulation described in this disclosure through an extruder including a thermally controlled gas injection and mixer In some embodiments, at least one layer of the multilayer sheet may be formed by mixing or extruding at least one polymer formulation described in this disclosure using an extruder with a thermally controlled gas injection and mixing unit. In some embodiments, at least one layer of the multilayer sheet may be formed by using a mixer or an extruder that includes special gas injectors for an efficient static and dynamic mixing of the polymer formulation by gas dispersion. In some embodiments, at least one layer of the multilayer sheet may be formed by using a mixer or an extruder that is configured for melt cooling with precise temperature control and a uniform temperature distribution in the polymer formulation.

In some embodiments, the temperature of the extruder may determine the opaqueness of the sheet. In some embodiments, the temperature of the extruder may determine the density of the sheet. In some embodiments, each layer of the sheet may be formed by extruding at least one polymer formulation described in this disclosure through a melt blender included in the extruder. In some embodiments, the position of the plug may be determined based on a desired material distribution on the sheet.

In some embodiments, the polymer sheet may be subjected to heated rollers after extrusion. Heated rolled maybe used on the sheet after all layers are co-extruded to allow uniform crystallization in the sheet. The heated rollers may be operated at a temperature of about 85° C. to about 160° C., including any temperature or range comprised therein. The temperature of the heated rollers may range from about 85° C. to about 90° C., about 90° C. to about 95° C., about 95° C. to about 100° C., about 100° C. to about 105° C., about 105° C. to about 110° C., about 110° C. to about 120° C., about 120° C. to about 130° C., about 130° C. to about 140° C., about 140° C. to about 150° C., or about 150° C. to about 160° C. The heated rollers may be cooled by using water and/or oil.

In some embodiments, the polymer sheet may have a temperature of about 140° C. to about 170° C., including any temperature or range comprised therein. The sheet may have a temperature of about 140° C. to about 145° C., about 145° C. to about 150° C., about 150° C. to about 155° C., about 155° C. to about 160° C., about 160° C. to about 165° C., or about 165° C. to about 170° C. In some examples, the sheet is kept warm prior to thermoforming by heated rollers. These heated rollers help permit the beta nucleating agent to work to form beta crystals.

In some embodiments, the multilayer sheet may comprise a foamed layer or core layer made from a foamed polymer formulation or core polymer formulation that comprises a polymer and one or more additives. In some embodiments, the core polymer formulation may be passed through an extruder with a blowing agent to form the core layer. In some embodiments, the blowing agent may be a physical blowing agent. In some embodiments, the blowing agent may be carbon dioxide, nitrogen, inert gas, or any suitable combination or alternatives. In some embodiments, the polymer may be polypropylene. In some embodiments, the core polymer formulation may comprise a high melt strength polymer. In some embodiments, a high melt strength polymer may be used in the core polymer formulation to minimize corrugation. In some embodiments, the core polymer formulation may further comprise regrind. In some embodiments, the additive used in the core polymer formulation may be a beta nucleating agent. In some embodiments, the additive used in the core polymer formulation may be a foam cell nucleating agent (e.g., procell). In some embodiments, the regrind may include a beta nucleating agent. In some embodiments, the additive used in the core polymer formulation may be a colorant. In some embodiments, the colorant may be J11 (Ampacet). In some embodiments, the core polymer formulation may be substantially free of a colorant, such as titanium dioxide.

In some embodiments, the multilayer sheet may comprise one or more non-foamed layers or skin layers or outer layers made from a non-foamed polymer formulation. The non-foamed layers or skin layers or outer layers are positioned adjacent to the foamed layer or core layer. The non-foamed polymer formulation may comprise a polymer and one or more additives. In some embodiments, the non-foamed polymer formulation may be passed through an extruder without a blowing agent to form the non-foamed layer. In some embodiments, the blowing agent may be a physical blowing agent. In some embodiments, the blowing agent may be carbon dioxide, nitrogen, inert gas, or any suitable combination or alternatives. In some embodiments, the polymer may be polypropylene. In some embodiments, the non-foamed polymer formulation may further comprise regrind. In some embodiments, the non-foamed polymer formulation may comprise a high melt strength polymer. In some embodiments, a high melt strength polymer may be used in the non-foamed polymer formulation to minimize corrugation. In some embodiments, the additive used in the non-foamed polymer formulation may be a beta nucleating agent. In some embodiments, the additive used in the non-foamed polymer formulation may be a colorant. In some embodiments, the non-foamed polymer formulation may be substantially free of a colorant.

In some embodiments, the multilayer sheet may comprise an opaque layer without the inclusion of a colorant in the polymer formulation used to make that layer. In some embodiments, one or more layers of the multilayer sheet may be opaque because of the presence of microvoids. The microvoids may be foamed cells formed during the making of the foamed layer. In some embodiments, one or more layers of the multilayer sheet may be opaque because of the presence of microvoids and a colorant. In some embodiments, the multilayer sheet may comprise a white layer without the inclusion of a colorant in the polymer formulation used to make that layer. In some embodiments, one or more layers of the multilayer sheet may have a pearl white appearance without the inclusion of a colorant in the polymer formulation used to make that layer.

In some embodiments, all layers of the multilayer sheet may comprise the same thickness. In some embodiments, at least one layer of the multilayer sheet may comprise a thickness different from the thickness of all the other layers. In some embodiments, at least two layers of the multilayer sheet may comprise the same thickness. In some embodiments, the thickness of a layer of the multilayer sheet may range from about 2% to about 90% of the multilayer sheet, including any suitable percentage or range comprised therein. In some embodiments, the thickness of a layer of the multilayer sheet may be about 2% to about 5%, about 5% to about 10%, about 10% to about 15%, about 15% to about 20%, about 20% to about 25%, about 25% to about 30%, about 30% to about 35%, about 35% to about 40%, about 40% to about 45%, about 45% to about 50%, about 50% to about 55%, about 55% to about 60%, about 60% to about 65%, about 65% to about 70%, about 70% to about 75%, about 75% to about 80%, about 80% to about 85%, about 85% to about 90% of the multilayer sheet.

In some embodiments, the multilayer sheet may comprise one foamed layer and one non-foamed layer. In some embodiments, the multilayer sheet may comprise one foamed layer and more than one non-foamed layer. In some embodiments, the multilayer sheet may comprise more than one non-foamed layer made of the same non-foamed polymer formulation. In some embodiments, the multilayer sheet may comprise more than one non-foamed layer and at least two of the non-foamed layers may be made of different non-foamed polymer formulation. In some embodiments, the multilayer sheet may comprise a monolayer of foamed sheet.

In some embodiments, one or more layers of the multilayer sheet may have a density that is lower than the density of the native polymer used to make that layer. See Table #1.

TABLE 1
Density of different layers of a multilayer sheet

| | | | | Avg | | |
|---|---|---|---|---|---|---|
| | | | | Measured | Theoretical | |
| | Sample | Sample | Sample | Density | Density | % |
| # | 1 | 2 | 3 | (kg/m3) | (kg/m3) | Difference |
| 1 | 302 | 302 | 299 | 301 | 290 | 3.7% |
| 2 | 526 | 524 | 527 | 526 | 510 | 3.0% |
| 3 | 468 | 474 | 470 | 471 | 470 | 0.2% |
| 4 | 912 | 906 | 912 | 910 | | |

In some embodiments, each layer of the multilayer sheet may have a density that is about 0.1% to about 0.5%, about 0.5% to about 1%, about 1% to about 5%, about 5% to about 10%, about 10% to about 15%, about 15% to about 20%, 20% to about 25%, about 25% to about 30%, about 30% to about 35%, about 35% to about 40%, about 40% to about 45%, about 45% to about 50% lower than the density of the native polymer used to make that layer. In some embodiments, the density of each layer of the multilayer sheet may range from about to 400 kg/m³ about 900 kg/m³. In some embodiments, the density of a foamed layer of the multilayer sheet may range from about 400 kg/m³ to about 500 kg/m³. In some embodiments, the density of a non-foamed layer of the multilayer sheet may range from about 500 kg/m³ to about 700 kg/m³. In some embodiments, the density of a non-foamed layer of the multilayer sheet may range from about 700 kg/m³ to about 900 kg/m³.

In one illustrative embodiment, the present disclosure provides a multilayer sheet including a first layer that is a skin layer or an outer layer or a non-foamed layer arranged to provide an outer surface, a second layer that is a skin layer or an outer layer or a non-foamed layer arranged to provide an inner surface, and a third layer that is a core layer or a foamed layer arranged to extend between and interconnect the first layer and the second layer. In some embodiments, as shown in FIG. 4A, a multilayer polymer sheet 30 may include a first non-foamed layer 32 and a second non-foamed layer 36 (layers A) may be made of the same non-foamed polymer formulation. Each of the first and the second layers 32, 36 comprise thickness or a wt % of about 20% of the multilayer sheet. A third layer 34 (layer B) may be a foamed layer comprised of a foamed polymer formulation and comprise thickness or a wt % of about 60% of the multilayer polymer sheet 30. Alternatively, as shown in FIG. 4B, a multilayer polymer sheet 40 may include a first non-foamed layer 42 and a second non-foamed layer 46 made of the different non-foamed polymer formulations. The first outer non-foamed layer 42 (layer A) and the second outer non-foamed layer 46 (layer C) may be made of different non-foamed polymer formulation. Each of the first and the second non-foamed layers 42, 46 may comprise thickness or a wt % of about 20% of the multilayer sheet. The third layer (layer B) may be a foamed layer 44 made of a foamed polymer formulation and comprises a thickness or wt % of about 60% of the multilayer sheet. In some embodiments, as shown in FIGS. 4C-4D, a polymer sheet 50, 60 may be comprised of two layers. The inner layer 64 (layer A) may be made of a non-foamed polymer formulation and the outer layer 62 (layer B) may be made up of a foamed polymer formulation in the polymer sheet 60 (FIG. 4D). Alternatively, the outer layer 52 (layer A) may be made of a non-foamed polymer formulation and the inner layer 54 (layer B) may be made up of a foamed polymer formulation in the polymer sheet 50 (FIG. 4C). In some embodiments, as shown in FIG. 4E, a multilayer polymer sheet 70 may be comprised of multiple layers including the first outer non-foamed layer 72 (layer A) and an inner non-foamed layer 78 comprising a non-foamed polymer formulation. The multilayer polymer sheet 70 may include a foamed layer 76 comprising a foamed formulation (layer B). The multilayer polymer sheet 70 may also include 1-N additional suitable layers 74, where N could range from 2 to 20, including any number or range comprised therein. In some embodiments, the suitable layer may be an oxygen barrier layer (e.g., EVOH) with any associated compatibilization layers.

In other embodiments, the multilayer sheet may comprise different permutations and combinations of the foamed and non-foamed layers. In some embodiments, each of the first and the second layers may comprise a thickness or wt % of about 15% of the multilayer sheet. The third layer middle may comprise a thickness or wt % of about 70% of the multilayer sheet. In some embodiments, each of the first and the second layers may comprise a thickness or wt % of about 10% of the multilayer sheet. The third layer middle may comprise a thickness or wt % of about 80% of the multilayer sheet. In other embodiments, the thickness or wt % of each layer may be different than those exemplified. In some embodiments, each of the first and the second layers may comprise a thickness or wt % of about 5% to about 40% of the multilayer sheet, including any range of percentage comprised therein. In some embodiments, the core layer may comprise a thickness or wt % of about 5% to about 80% of the multilayer sheet, including any range of percentage comprised therein. In some embodiments, each of the first and the second layers may comprise a different thickness or wt % of the multilayer sheet.

### Containers

In another aspect, the present disclosure is directed to a container or structure made out of the polymer sheets described in this disclosure. In some embodiments, the container may be used to transport, store, serve, or consume food products. In some embodiments, the container may be used to transport, store, or serve a water-based or liquid-based product. In some embodiments, the container may be used to transport, store, or serve any other suitable product.

In some embodiments, a container according to the present disclosure may comprise a polymer sheet with multiple layers. In some embodiments, a container according to the present disclosure may comprise a polymer sheet with two or more layers. In some embodiments, a container may comprise a polymer sheet with at least one foamed layer and at least one non-foamed layer. In some embodiments, a container may comprise a thermoformed polymer sheet with at least one foamed layer and more than one non-foamed layer. In some embodiments, the container is a drinking cup 100, as shown in FIG. 5A. In some embodiments, the container is a food container 102, as shown in FIG. 5B. In some embodiments, the container is a yogurt container 104, as shown in FIG. 5D. In some embodiments, a container 106 may have an in-mold label 110 attached to a base 108, as shown in FIG. 5C.

In some embodiments, the container made according to the present disclosure may comprise an opaque layer without the inclusion of a colorant in the polymer formulation used to make that layer. In some embodiments, the container made according to the present disclosure may be opaque because of the presence of microvoids. In some embodiments, the container made according to the present disclosure may be opaque because of the presence of microvoids and a colorant. In some embodiments, the container made according to the present disclosure may comprise a white layer without the inclusion of a colorant in the polymer formulation used to make that layer. In some embodiments, the container made according to the present disclosure may have a pearl white appearance without the inclusion of a colorant in the polymer formulation used to make that layer. In some embodiments, at least one side of the container made according to the present disclosure may be pearly white in color without the inclusion of any colorant. In some embodiment, an inner layer of the polymer sheet used to make a container, i.e, the side of the sheet in contact with the food being stored in the container may not have any colorant or many be naturally colored.

In some embodiments, a container made according to the present disclosure may weigh less than a typical container of that size. In some embodiments, a container according to embodiments of the present disclosure may weigh about 5% to about 10%, about 10% to about 15%, about 15% to about 20%, or about 20% to about 25% less than a typical container of that size.

In some embodiments, a container made according to the present disclosure may have a higher wall rigidity than a comparative container of that size. In some embodiments, a container according to embodiments of the present disclosure may have a wall rigidity that is about 5% to about 10%, about 10% to about 15%, about 15% to about 20%, about 20% to about 25%, about 25% to about 30%, about 30% to about 35%, about 35% to about 40%, about 40% to about 45%, or about 45% to about 50% more than a typical container of that size.

In some embodiments, a container according to embodiments of the present disclosure may have a wall rigidity that is about 0.396 kgF to about 0.448 kgF, including any value or range comprised therein compared to a standard rigidity of about 0.376 kgF to about 0.413 kgF.

In some embodiments, a container made according to the present disclosure may comprise an opaque structure formed without the inclusion of a colorant.

In some embodiments, a container made according to the present disclosure may withstand a top load of about 21 lbf to about 22 lbf, including any weight or range comprised therein during a general compression test of 5 kN-2 inches/min. This is in comparison to a standard top load of about 25.64 lbf.

To provide a more concise description, some of the quantitative expressions given herein are not qualified with the term “about.” It is understood that, whether the term “about” is used explicitly or not, every quantity given herein is meant to refer to the actual given value, and it is also meant to refer to the approximation to such given value that would reasonably be inferred based on the ordinary skill in the art, including equivalents and approximations due to the experimental and/or measurement conditions for such given. If those equivalents and approximations cannot be determined, then “about” may refer to, for example, within 5% of the cited value.

Any composition disclosed herein may comprise, consist of, or consist essentially of any suitable element or component disclosed herein or any suitable combination of two or more of the elements or components disclosed herein. Furthermore, the present disclosure encompasses any and all suitable possible combinations of some or all of the various embodiments described herein.

### EXAMPLES

The following examples and representative procedures illustrate features in accordance with the present disclosure and are provided solely by way of illustration. They are not intended to limit the scope of the appended claims or their equivalents. Parts and percentages appearing in such examples are by volume, or thickness, unless otherwise stipulated. All ASTM, ISO, and other standard test methods cited or referred to in this disclosure are incorporated by reference in their entirety.

### Example 1—Comparative Container

As shown in Table #2, a container was made with a multilayer sheet comprising 3 layers. All three layers comprised the same polymer formulation including polymers SC204 (LyndonBassell), 6023N (Braskem), and colorant J11 (Ampacet). Each of the outer layers comprises 10% of the multilayer sheet. The core layer comprises 80% of the multilayer sheet.

TABLE 2
Iteration 1.0 and 1.1 - Standard Dairy

| | | | | | | MPM | | | Gas Dose | |
|---|---|---|---|---|---|---|---|---|---|---|
| Top of Sheet (inside of part) | SC204 | 6023N | J11 | 6025 | WB140 | S [symbol] -2000 [symbol] | Pro Nuc | Calcium | (g/hr) | Layer % |
| Extruder B material | 53.8% | 42.2% | 4.0% | | | | | | | 10% |
| Extruder A material | 53.8% | 42.2% | 4.0% | | | | | | 0 | 80% |
| Extruder B material | 53.8% | 42.2% | 4.0% | | | | | | | 10% |

| | | | |
|---|---|---|---|
| Bottom of Sheet (outside of part) | Gauge (in) | 0.0413 | 100.00% |

[symbol]

indicates data missing or illegible when filed

### Example 2—Comparative Container

As shown in Table #3, a container was made with a multilayer sheet comprising 3 layers. The two outer layers comprised the same polymer formulation including polymers SC204 (LyndonBassell) and 6023N (Braskem), and colorant J11 (Ampacet). The core layer comprised a polymer formulation comprising SC204 (LyndonBassell) and 6023N (Braskem) with a gas flow rate of 9 g/ml. About 70% foam-cell nucleating agent (procell) was used in the core layer, which resulted in about 20% reduction in density. Each of the outer layers comprises 10% of the multilayer sheet. The core layer comprises 80% of the multilayer sheet.

TABLE 3
Iteration 2.0 - Standard Dairy + 20% Density Reduction (No Core Color)

| | | | | | | MPM | | | Gas Dose | |
|---|---|---|---|---|---|---|---|---|---|---|
| Top of Sheet (inside of part) | SC204 | 6023N | J11 | 6025 | WB140 | S-2000ly | Pro Nuc | Calcium | g/hr | Layer % |
| Extruder B material | 53.8% | 42.2% | 4.0% | | | | | | | 10% |
| Extruder A material | 55.3% | 44.0% | | | | | 0.70% | | 9 | 80% |
| Extruder B material | 53.8% | 42.2% | 4.0% | | | | | | | 10% |

| | | | |
|---|---|---|---|
| Bottom of Sheet (outside of part) | Gauge (in) | 0.0413 | 100.00% |

### Example 3—Comparative Container

As shown in Table #4, a container was made with a multilayer sheet comprising 3 layers. The two outer layers comprised the same polymer formulation including polymers SC204 (LyndonBassell) and 6023N (Braskem), and colorant J11 (Ampacet). The core layer comprised a polymer formulation comprising SC204 (LyndonBassell) and 6023N (Braskem) with a gas flow rate of 5 g/ml. About 70% foam-cell nucleating agent (procell) was used in the core layer, which resulted in about 20% reduction in density. Each of the outer layers comprises 10% of the multilayer sheet. The core layer comprises 80% of the multilayer sheet.

TABLE 4
Iteration 2.1 - Standard Dairy + 20% Density Reduction (No Core Color)

| | | | | | | MPM | | | Gas Dose | |
|---|---|---|---|---|---|---|---|---|---|---|
| Top of Sheet (inside of part) | SC204 | 6023N | J11 | 6025 | WB140 | S-2000y | Pro Nuc | Calcium | g/hr | Layer % |
| Extruder B material | 53.8% | 42.2% | 4.0% | | | | | | | 10% |
| Extruder A material | 55.3% | 44.0% | | | | | 0.70% | | 5 | 80% |
| Extruder B material | 53.8% | 42.2% | 4.0% | | | | | | | 10% |

| | | | |
|---|---|---|---|
| Bottom of Sheet (outside of part) | Gauge (in) | 0.0413 | 100.00% |

### Example 4—Sheet with 2% Beta Nucleating Agent and Colorant

As shown in Table #5, a container was made with a multilayer sheet comprising 3 layers. The two outer layers comprised the same polymer formulation including polymer 6025 (Braskem) and colorant J11 (Ampacet). The core layer comprised a polymer formulation comprising 6025 (Braskem) and 2% beta nucleating agent. Each of the outer layers comprises 10% of the multilayer sheet. The core layer comprises 80% of the multilayer sheet.

TABLE 5
Iteration 5.0 - 6025 + 2% Superfly (Superfly Control) with color

| | | | | | | MPM | | | Gas Dose | |
|---|---|---|---|---|---|---|---|---|---|---|
| Top of Sheet (inside of part) | SC204 | 6023N | J11 | 6025 | WB140 | S-2000y | Pro Nuc | Calcium | g/hr | Layer % |
| Extruder B material | | | 4.0% | [symbol] | | | | | | 10% |
| Extruder A material | | | | 98.0% | | 2.0% | | | 0 | 80% |
| Extruder B material | | | 4.0% | [symbol] | | | | | | 10% |

| | | | |
|---|---|---|---|
| Bottom of Sheet (outside of part) | Gauge (in) | 0.0413 | 100.00% |

[symbol]

indicates data missing or illegible when filed

### Example 5—Sheet with 2% Beta Nucleating Agent and No Colorant

As shown in Table #6, a container was made with a multilayer sheet comprising 3 layers. The two outer layers comprised the same polymer formulation including polymer 6025 (Braskem). The core layer comprised a polymer formulation comprising 6025 (Braskem) and 2% beta nucleating agent. Each of the outer layers comprises 10% of the multilayer sheet. The core layer comprises 80% of the multilayer sheet.

TABLE 6
Iteration 5.1 - 6025 + 2% Superfly (Superfly Control) WITHOUT color

| | | | | | | MPM | | | Gas Dose | |
|---|---|---|---|---|---|---|---|---|---|---|
| Top of Sheet (inside of part) | SC204 | 6023N | J11 | 6025 | WB140 | S-2000ly | Pro Nuc | Calcium | g/hr | Layer % |
| Extruder B material | | | | 100.0% | | | | | | 10% |
| Extruder A material | | | | 98.0% | | 2.0% | | | 0 | 80% |
| Extruder B material | | | | 100.0% | | | | | | 10% |

| | | | |
|---|---|---|---|
| Bottom of Sheet (outside of part) | Gauge (in) | 0.0413 | 100.00% |

### Example 6—Sheet with 2% Beta Nucleating Agent, No Colorant, and a Reduced Gas Density

As shown in Table #7, a container was made with a multilayer sheet comprising 3 layers. The two outer layers comprised the same polymer formulation including polymer 6025 (Braskem). The core layer comprised a polymer formulation comprising 6025 (Braskem) and 2% beta nucleating agent with a reduced gas density, and a gas flow rate of 100 g/hr. Each of the outer layers comprises 10% of the multilayer sheet. The core layer comprises 80% of the multilayer sheet.

TABLE 7
Iteration 6.0 - 6025 + 2% Superfly WITHOUT color - gas density reduced

| | | | | | | MPM | | | Gas Dose | |
|---|---|---|---|---|---|---|---|---|---|---|
| Top of Sheet (inside of part) | SC204 | 6023N | J11 | 6025 | WB140 | S [symbol] -2000 y | Pro Nuc | Calcium | g/hr | Layer % |
| Extruder B material | | | | 100.0% | | | | | | 10% |
| Extruder A material | | | | 98.0% | | 2.0% | | | 100 | 80% |
| Extruder B material | | | | 100.0% | | | | | | 10% |

| | | | |
|---|---|---|---|
| Bottom of Sheet (outside of part) | Gauge (in) | 0.0413 | 100.00% |

[symbol]

indicates data missing or illegible when filed

### Example 7—Sheet with 2% Beta Nucleating Agent, Reduced Gas Density, Calcium, and No Colorant

As shown in Table #8, a container was made with a multilayer sheet comprising 3 layers. The two outer layers comprised the same polymer formulation including polymer 6025 (Braskem). The core layer comprised a polymer formulation comprising 6025 (Braskem), 1% calcium, and 2% beta nucleating agent with a reduced gas density and a gas flow rate of 5 g/hr. Each of the outer layers comprises 10% of the multilayer sheet. The core layer comprises 80% of the multilayer sheet.

TABLE 8
Iteration 6.1 - 6025 + 2% Superfly WITHOUT color - gas density reduced + Calcium

| | | | | | | MPM | | | Gas Dose | |
|---|---|---|---|---|---|---|---|---|---|---|
| Top of Sheet (inside of part) | SC204 | 6023N | J11 | 6025 | WB140 | S-2000 y | Pro Nuc | Calcium | g/hr | Layer % |
| Extruder B material | | | | 100.0% | | | | | | 10% |
| Extruder A material | | | | 97.0% | | 2.0% | | 1.0% | 5 | 80% |
| Extruder B material | | | | 100.0% | | | | | | 10% |

| | | | |
|---|---|---|---|
| Bottom of Sheet (outside of part) | Gauge (in) | 0.0413 | 100.00% |

### Example 8—Sheet with 2% Beta Nucleating Agent, Reduced Gas Density, Foam-Cell Nucleating Agent, and No Colorant

As shown in Table #9, a container was made with a multilayer sheet comprising 3 layers. The two outer layers comprised the same polymer formulation including polymer 6025 (Braskem). The core layer comprised a polymer formulation comprising 6025 (Braskem), 2% beta nucleating agent, and about 0.7% foam-cell nucleating agent (procell) with a reduced gas density and a gas flow rate of 5 g/hr. Each of the outer layers comprises 10% of the multilayer sheet. The core layer comprises 80% of the multilayer sheet.

TABLE 9
Iteration 6.2 - 6025 + 2% Superfly WITHOUT color - gas density reduced + Procell

| | | | | | | MPM | | | Gas Dose | |
|---|---|---|---|---|---|---|---|---|---|---|
| Top of Sheet (inside of part) | SC204 | 6023N | J11 | 6025 | WB140 | S-2000ly | Pro Nuc | Calcium | g/hr | Layer % |
| Extruder B material | | | | 100.0% | | | | | | 10% |
| Extruder A material | | | | 97.3% | | 2.0% | 0.7% | | 5 | 80% |
| Extruder B material | | | | 100.0% | | | | | | 10% |

| | | | |
|---|---|---|---|
| Bottom of Sheet (outside of part) | Gauge (in) | 0.0413 | 100.00% |

### Example 9—Sheet with Foam-Cell Nucleating Agent

As shown in Table #10, a container was made with a multilayer sheet comprising 3 layers. The two outer layers comprised the same polymer formulation including polymer 6025 (Braskem). The core layer comprised a polymer formulation comprising SC204 (LyndonBassell), 6023N (Braskem), and about 0.8% foam-cell nucleating agent (procell) with a gas flow rate of 5 g/hr. Each of the outer layers comprises 10% of the multilayer sheet. The core layer comprises 80% of the multilayer sheet.

TABLE 10
Iteration 3.0 & 3.1 & 3.2 - SC204 6023N core foam - 6025 caps

| | | | | | | MPM | | | Gas Dose | |
|---|---|---|---|---|---|---|---|---|---|---|
| Top of Sheet (inside of part) | SC204 | 6023N | J11 | 6025 | WB140 | [symbol] -2000 [symbol] ly | Pro Nuc | Calcium | g/hr | Layer % |
| Extruder B material | | | | 100.0% | | | | | | 10% |
| Extruder A material | 43.9% | 55.3% | | | | | 0.8% | | 5 | 80% |
| Extruder B material | | | | 100.0% | | | | | | 10% |

| | | | |
|---|---|---|---|
| Bottom of Sheet (outside of part) | Gauge (in) | 0.0413 | 100.00% |

[symbol]

indicates data missing or illegible when filed

### Example 10—Sheet with Beta Nucleating Agent

As shown in Table #11, a container was made with a multilayer sheet comprising 3 layers. The two outer layers comprised the same polymer formulation including polymer 6025 (Braskem) and about 2% beta nucleating agent. The core layer comprised a polymer formulation comprising SC204 (LyndonBassell), 6023N (Braskem), and about 0.8% foam-cell nucleating agent (procell) with a gas flow rate of 5.6 g/hr. Each of the outer layers comprises 10% of the multilayer sheet. The core layer comprises 80% of the multilayer sheet.

TABLE 11
3.3 - SC204 6023N core foam - superfly cap

| | | | | | | MPM | | | Gas Dose | |
|---|---|---|---|---|---|---|---|---|---|---|
| Top of Sheet (inside of part) | SC204 | 6023N | J11 | 6025 | WB140 | -2000fly | Pro Nuc | Calcium | g/hr | Layer % |
| Extruder B material | | | | 98.0% | | 2.0% | | | | 10% |
| Extruder A material | 43.9% | 55.3% | | | | | 0.8% | | 5.6 | 80% |
| Extruder B material | | | | 98.0% | | 2.0% | | | | 10% |

| | | | |
|---|---|---|---|
| Bottom of Sheet (outside of part) | Gauge (in) | 0.0413 | 100.00% |

### Example 11—Sheet with Beta Nucleating Agent

As shown in Table #12, a container was made with a multilayer sheet comprising 3 layers. The two outer layers comprised the same polymer formulation including polymer 6025 (Braskem) and about 2% beta nucleating agent. The core layer comprised a polymer formulation comprising SC204 (LyndonBassell), 6023N (Braskem), and about 0.8% foam-cell nucleating agent (procell) with a gas flow rate of 5.6 g/hr. Each of the outer layers comprises 20% of the multilayer sheet. The core layer comprises 60% of the multilayer sheet.

TABLE 12
3.4-SC204 6023N core foam - superfly cap 20/60/20

| | MPM | | | | | | | | Gas Dose | |
|---|---|---|---|---|---|---|---|---|---|---|
| Top of Sheet (inside of part) | SC204 | 6023N | J11 | 6025 | WB140 | [symbol] 2000 [symbol] | Pro Nuc | Calcium | g/hr | Layer % |
| Extruder B material | | | | 98.0% | | 2.0% | | | | 20% |
| Extruder A material | 43.9% | 55.3% | | | | | 0.8% | | 5.6 | 60% |
| Extruder B material | | | | 98.0% | | 2.0% | | | | 20% |
| Bottom of Sheet (outside of part) | | | | | | | Gauge (in) | | | 100.00% |

[symbol]

indicates data missing or illegible when filed

### Example 12—Sheet with Beta Nucleating Agent

As shown in Table #13, a rollstock was made with a multilayer sheet comprising 3 layers. The two outer layers comprised the same polymer formulation including polymer 6025 (Braskem) and about 2% beta nucleating agent. The core layer comprised a polymer formulation comprising SC204 (LyndonBassell), 6023N (Braskem), and about 0.8% foam-cell nucleating agent (procell) with a gas flow rate of 5.6 g/hr. Each of the outer layers comprises 10% of the multilayer sheet. The core layer comprises 80% of the multilayer sheet.

TABLE 13
3.5 - SC204 6023N core foam - superfly cap - making rollstock

| | MPM | | | | | | | | Gas Dose | |
|---|---|---|---|---|---|---|---|---|---|---|
| Top of Sheet (inside of part) | SC204 | 6023N | J11 | 6025 | WB140 | [symbol] 2000 [symbol] | Pro Nuc | Calcium | g/hr | Layer % |
| Extruder B material | | | | 98.0% | | 2.0% | | | | 10% |
| Extruder A material | 43.9% | 55.3% | | | | | 0.8% | | 5.6 | 80% |
| Extruder B material | | | | 98.0% | | 2.0% | | | | 10% |
| Bottom of Sheet (outside of part) | | | | | | | Gauge (in) | | | 100.00% |

[symbol]

indicates data missing or illegible when filed

### Example 13—Sheet with Foam-Cell Nucleating Agent, Beta Nucleating Agent, and Colorant

As shown in Table #14, a rollstock was made with a multilayer sheet comprising 3 layers. The two outer layers comprised the same polymer formulation including polymer 6025 (Braskem), colorant J11 (Ampacet), and about 2% beta nucleating agent. The core layer comprised a polymer formulation comprising SC204 (LyndonBassell), 6023N (Braskem), and about 0.8% foam-cell nucleating agent (procell) with a gas flow rate of 5.6 g/hr. Each of the outer layers comprises 10% of the multilayer sheet. The core layer comprises 80% of the multilayer sheet.

TABLE 14
3.6 - SC204 6023N core foam - superfly cap + white - making rollstock

| | MPM | | | | | | | | Gas Dose | |
|---|---|---|---|---|---|---|---|---|---|---|
| Top of Sheet (inside of part) | SC204 | 6023N | J11 | 6025 | WB140 | [symbol] 2000 [symbol] | Pro Nuc | Calcium | g/hr | Layer % |
| Extruder B material | | | 2.0% | 96.0% | | 2.0% | | | | 10% |
| Extruder A material | 43.9% | 55.3% | | | | | 0.8% | | 5.6 | 80% |
| Extruder B material | | | 2.0% | 96.0% | | 2.0% | | | | 10% |
| Bottom of Sheet (outside of part) | | | | | | | Gauge (in) | | | 100.00% |

[symbol]

indicates data missing or illegible when filed

### Example 14—Sheet with Beta Nucleating Agent and Adjusted Process Settings

As shown in Table #15, a container was made with a multilayer sheet comprising 3 layers. The two outer layers comprised the same polymer formulation including polymer 6025 (Braskem) about 2% beta nucleating agent. The core layer comprised a polymer formulation comprising SC204 (LyndonBassell), 6023N (Braskem), and about 0.8% foam-cell nucleating agent (procell) with a gas flow rate of 5.6 g/hr. Each of the outer layers comprises 10% of the multilayer sheet. The core layer comprises 80% of the multilayer sheet.

TABLE 15
4.0 (same as 3.5) - SC204 6023N core foam - superfly cap - promix adjusting settings

| | MPM | | | | | | | | Gas Dose | |
|---|---|---|---|---|---|---|---|---|---|---|
| Top of Sheet (inside of part) | SC204 | 6023N | J11 | 6025 | WB140 | [symbol] 2000 [symbol] | Pro Nuc | Calcium | g/hr | Layer % |
| Extruder B material | | | | 98.0% | | 2.0% | | | | 10% |
| Extruder A material | 43.9% | 55.3% | | | | | 0.8% | | 5.6 | 80% |
| Extruder B material | | | | 98.0% | | 2.0% | | | | 10% |
| Bottom of Sheet (outside of part) | | | | | | | Gauge (in) | | | 100.00% |

[symbol]

indicates data missing or illegible when filed

### Example 15—Sheet with Foam-Cell Nucleating Agent

As shown in Table #16, a container was made with a multilayer sheet comprising 3 layers. The two outer layers comprised the same polymer formulation including polymer 6025 (Braskem). The core layer comprised a polymer formulation comprising polymer 6025 (Braskem) and about 0.8% foam-cell nucleating agent (procell) with a gas flow rate of 5.6 g/hr. Each of the outer layers comprises 10% of the multilayer sheet. The core layer comprises 80% of the multilayer sheet.

TABLE 16
5.0B - 6025

| | MPM | | | | | | | | Gas Dose | |
|---|---|---|---|---|---|---|---|---|---|---|
| Top of Sheet (inside of part) | SC204 | 6023N | J11 | 6025 | WB140 | [symbol] 2000 [symbol] | Pro Nuc | Calcium | g/hr | Layer % |
| Extruder B material | | | | 100.0% | | | | | | 10% |
| Extruder A material | | | | 99.2% | | | 0.8% | | 5.6 | 80% |
| Extruder B material | | | | 100.0% | | | | | | 10% |
| Bottom of Sheet (outside of part) | | | | | | | Gauge (in) | | | 100.00% |

[symbol]

indicates data missing or illegible when filed

### Example 16—Sheet with Beta Nucleating Agent

As shown in Table #17, a container was made with a multilayer sheet comprising 3 layers. The two outer layers comprised the same polymer formulation including polymer 6025 (Braskem) and about 2% beta nucleating agent. The core layer comprised a polymer formulation comprising polymer 6025 (Braskem) and about 0.8% foam-cell nucleating agent (procell) with a gas flow rate of 5.6 g/hr. Each of the outer layers comprises 10% of the multilayer sheet. The core layer comprises 80% of the multilayer sheet.

TABLE 17
5.1B Superfly

| | MPM | | | | | | | | Gas Dose | |
|---|---|---|---|---|---|---|---|---|---|---|
| Top of Sheet (inside of part) | SC204 | 6023N | J11 | 6025 | WB140 | [symbol] 2000 [symbol] | Pro Nuc | Calcium | g/hr | Layer % |
| Extruder B material | | | | 98.0% | | 2.0% | | | | 10% |
| Extruder A material | | | | 97.2% | | 2.0% | 0.8% | | 5.6 | 80% |
| Extruder B material | | | | 98.0% | | 2.0% | | | | 10% |
| Bottom of Sheet (outside of part) | | | | | | | Gauge (in) | | | 100.00% |

[symbol]

indicates data missing or illegible when filed

### Example 17—Sheet with Beta Nucleating Agent

As shown in Table #18, a container was made with a multilayer sheet comprising 3 layers. The two outer layers comprised the same polymer formulation including polymer 6025 (Braskem), colorant J11 (Ampacet), and about 2% beta nucleating agent. The core layer comprised a polymer formulation comprising polymer 6025 (Braskem), about 2% beta nucleating agent, and about 0.8% foam-cell nucleating agent (procell) with a gas flow rate of 5.6 g/hr. Each of the outer layers comprises 10% of the multilayer sheet. The core layer comprises 80% of the multilayer sheet.

TABLE 18
5.2 Superfly + white

| | MPM | | | | | | | | Gas Dose | |
|---|---|---|---|---|---|---|---|---|---|---|
| Top of Sheet (inside of part) | SC204 | 6023N | J11 | 6025 | WB140 | [symbol] 2000 [symbol] | Pro Nuc | Calcium | g/hr | Layer % |
| Extruder B material | | | 2.0% | 96.0% | | 2.0% | | | | 10% |
| Extruder A material | | | | 97.2% | | 2.0% | 0.8% | | 5.6 | 80% |
| Extruder B material | | | 2.0% | 96.0% | | 2.0% | | | | 10% |
| Bottom of Sheet (outside of part) | | | | | | | Gauge (in) | | | 100.00% |

[symbol]

indicates data missing or illegible when filed

### Example 18—Sheet with Beta Nucleating Agent

As shown in Table #19, a container was made with a multilayer sheet comprising 3 layers. The two outer layers comprised the same polymer formulation including polymer 6025 (Braskem), colorant J11 (Ampacet), and about 2% beta nucleating agent. The core layer comprised a polymer formulation comprising polymer 6025 (Braskem), about 2% beta nucleating agent, and about 0.8% foam-cell nucleating agent (procell) with a gas flow rate of 5.6 g/hr. Each of the outer layers comprises 10% of the multilayer sheet. The core layer comprises 80% of the multilayer sheet.

TABLE 19
5.3 Superfly reduced 1% + white

| | MPM | | | | | | | | Gas Dose | |
|---|---|---|---|---|---|---|---|---|---|---|
| Top of Sheet (inside of part) | SC204 | 6023N | J11 | 6025 | WB140 | [symbol] 2000 [symbol] | Pro Nuc | Calcium | g/hr | Layer % |
| Extruder B material | | | 1.0% | 97.0% | | 2.0% | | | | 10% |
| Extruder A material | | | | 97.2% | | 2.0% | 0.8% | | 5.6 | 80% |
| Extruder B material | | | 1.0% | 97.0% | | 2.0% | | | | 10% |
| Bottom of Sheet (outside of part) | | | | | | | Gauge (in) | | | 100.00% |

[symbol]

indicates data missing or illegible when filed

### Example 19—Core Layer with High Melt Strength Polymer

As shown in Table #10, a core layer was made a polymer formulation comprising 6025 (Braskem), about 10% high melt strength polymer (WB140), and about 0.7% foam-cell nucleating agent (procell) with a gas flow rate of 10 g/hr. In some embodiments, a multilayer sheet comprising this core layer would have two outer layers comprised of polymer formulation including polymer 6025 (Braskem), colorant J11 (Ampacet), and about 2% beta nucleating agent.

TABLE 20
7.0 6025 + 10% Borealis

| | MPM | | | | | | | | Gas Dose | |
|---|---|---|---|---|---|---|---|---|---|---|
| Top of Sheet (inside of part) | SC204 | 6023N | J11 | 6025 | WB140 | [symbol] -2000 [symbol] | Pro Nuc | Calcium | g/hr | Layer % |
| Extruder A material | | | | 89.3% | 10.0% | | 0.7% | | 10 | 100% |
| Bottom of Sheet (outside of part) | | | | | | | Gauge (in) | | | 100.00% |

[symbol]

indicates data missing or illegible when filed

### Example 20—Core Layer with High Melt Strength Polymer

As shown in Table #21, a core layer was made a polymer formulation comprising 6025 (Braskem), about 5% high melt strength polymer (WB140, Deploy), and about 0.7% foam-cell nucleating agent (procell) with a gas flow rate of 10 g/hr.

TABLE 21
7.1 6025 + 5% Borealis

| | MPM | | | | | | | | Gas Dose | |
|---|---|---|---|---|---|---|---|---|---|---|
| Top of Sheet (inside of part) | SC204 | 6023N | J11 | 6025 | WB140 | [symbol] 2000 [symbol] | Pro Nuc | Calcium | g/hr | Layer % |
| Extruder A material | | | | 94.3% | 5.0% | | 0.7% | | 10 | 100% |
| Bottom of Sheet (outside of part) | | | | | | | Gauge (in) | | | 100.00% |

[symbol]

indicates data missing or illegible when filed

### Example 21—Core Layer with High Melt Strength Polymer

As shown in Table #22, a core layer was made a polymer formulation comprising 6023N (Braskem), about 7.5% high melt strength polymer (WB140, Deploy), and about 0.7% foam-cell nucleating agent (procell) with a gas flow rate of 10 g/hr.

TABLE 22
7.2 6023N + 7% Borealis

| | MPM | | | | | | | | Gas Dose | |
|---|---|---|---|---|---|---|---|---|---|---|
| Top of Sheet (inside of part) | SC204 | 6023N | J11 | 6025 | WB140 | [symbol] 2000 [symbol] | Pro Nuc | Calcium | g/hr | Layer % |
| Extruder A material | | 91.8% | | | 7.5% | | 0.7% | | 10 | 100% |
| Bottom of Sheet (outside of part) | | | | | | | Gauge (in) | | | 100.00% |

[symbol]

indicates data missing or illegible when filed

### Example 22—Core Layer with High Melt Strength Polymer

As shown in Table #23, a core layer was made a polymer formulation comprising 6023N (Braskem), about 15% high melt strength polymer (WB140, Deploy), and about 0.7% foam-cell nucleating agent (procell) with a gas flow rate of 20 g/hr.

TABLE 23
7.3 6023N + 15% Borealis

| | MPM | | | | | | | | Gas Dose | |
|---|---|---|---|---|---|---|---|---|---|---|
| Top of Sheet (inside of part) | SC204 | 6023N | J11 | 6025 | WB140 | [symbol] 2000 [symbol] | Pro Nuc | Calcium | g/hr | Layer % |
| Extruder A material | | 84.3% | | | 15.0% | | 0.7% | | 20 | 100% |
| Bottom of Sheet (outside of part) | | | | | | | Gauge (in) | | | 100.00% |

[symbol]

indicates data missing or illegible when filed

### Example 23—Core Layer with High Melt Strength Polymer

As shown in Table #24, a core layer was made a polymer formulation comprising SC204 (LyndonBassell) and 6023N (Braskem), about 10% high melt strength polymer (WB140, Deploy), and about 0.7% foam-cell nucleating agent (procell) with a gas flow rate of 10 g/hr.

TABLE 24
8.0 TIML - Dairy + 10% Borealis

| | MPM | | | | | | | | Gas Dose | |
|---|---|---|---|---|---|---|---|---|---|---|
| Top of Sheet (inside of part) | SC204 | 6023N | J11 | 6025 | WB140 | [symbol] 2000 [symbol] | Pro Nuc | Calcium | g/hr | Layer % |
| Extruder A material | 39.5% | 49.8% | | | 10.0% | | 0.7% | | 10 | 100% |
| Bottom of Sheet (outside of part) | | | | | | | Gauge (in) | | | 100.00% |

[symbol]

indicates data missing or illegible when filed

### Example 24—Core Layer with High Melt Strength Polymer

As shown in Table #25, a core layer was made a polymer formulation comprising 6023N (Braskem), about 10% high melt strength polymer (WB140, Deploy), and about 0.7% foam-cell nucleating agent (procell) with a gas flow rate of 5.6 g/hr.

TABLE 25
8.1 TIML - Dairy + 10% Borealis

| | MPM | | | | | | | | Gas Dose | |
|---|---|---|---|---|---|---|---|---|---|---|
| Top of Sheet (inside of part) | SC204 | 6023N | J11 | 6025 | WB140 | [symbol] 2000 [symbol] | Pro Nuc | Calcium | g/hr | Layer % |
| Extruder A material | | 89.3% | | | 10.0% | | 0.7% | | 5.6 | 100% |
| Bottom of Sheet (outside of part) | | | | | | | Gauge (in) | | | 100.00% |

[symbol]

indicates data missing or illegible when filed

### Example 25—Top Load/Sidewall Buckle Testing

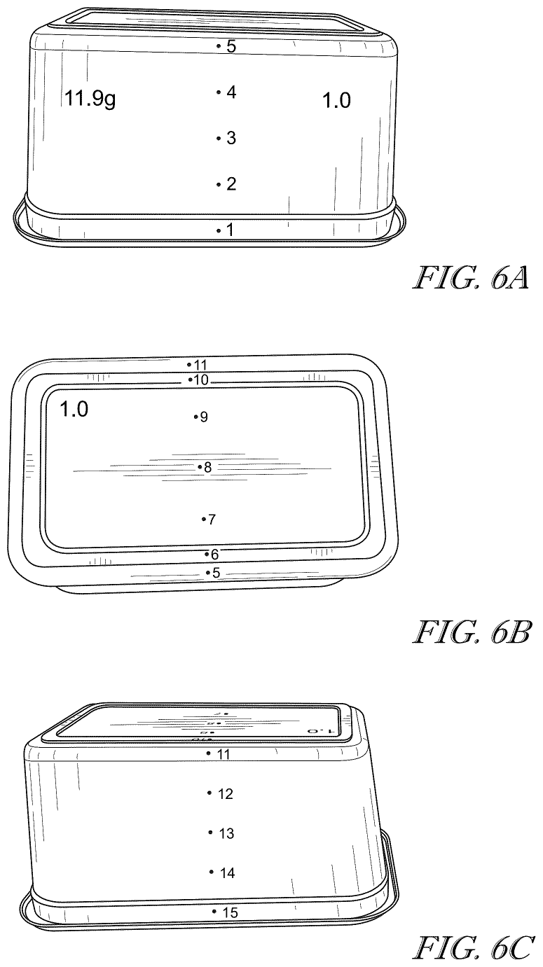

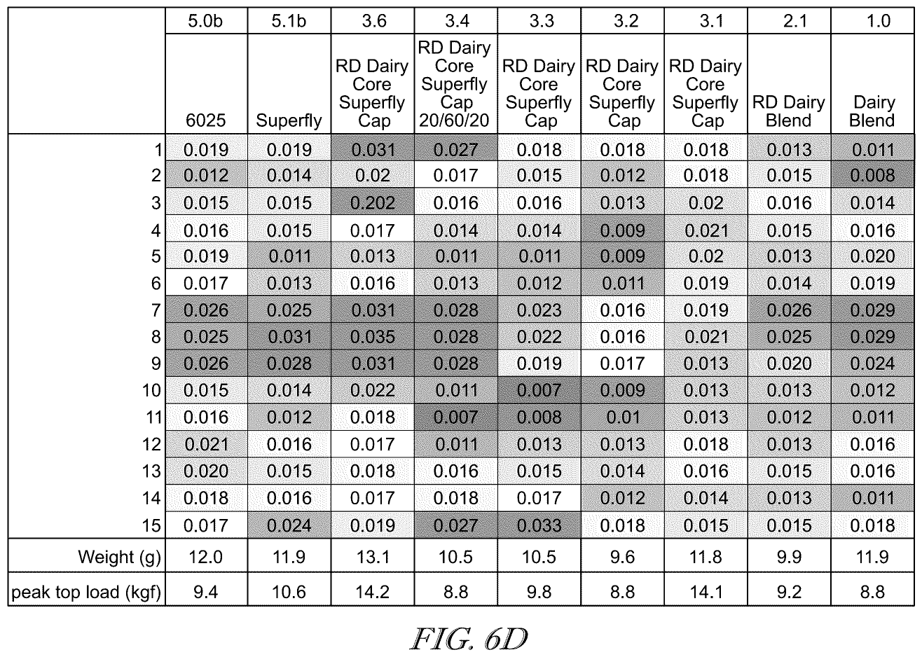

Top load and sidewall buckling were tested by measuring thickness as different locations along the sidewalls and base of a container in response to different loads as shown in FIGS. 6A-6D. FIG. 6D shows thickness across the identified locations for containers made with different polymer formulation. 5.0b refers to the polymer formulation described above in Example 4. 5.1b refers to the polymer formulation described above in Example 5. 3.6 refers to the polymer formulation described above in Example 10. 3.4 refers to the polymer formulation described above in Example 8. 3.3, 3.2, 3.1 refer to the polymer formulation described above in Example 7. 2.1 refers to the polymer formulation described above in Example 3. 1.0 refers to the polymer formulation described above in Example 1.

### Example 26—Gram Weight and Rigidity

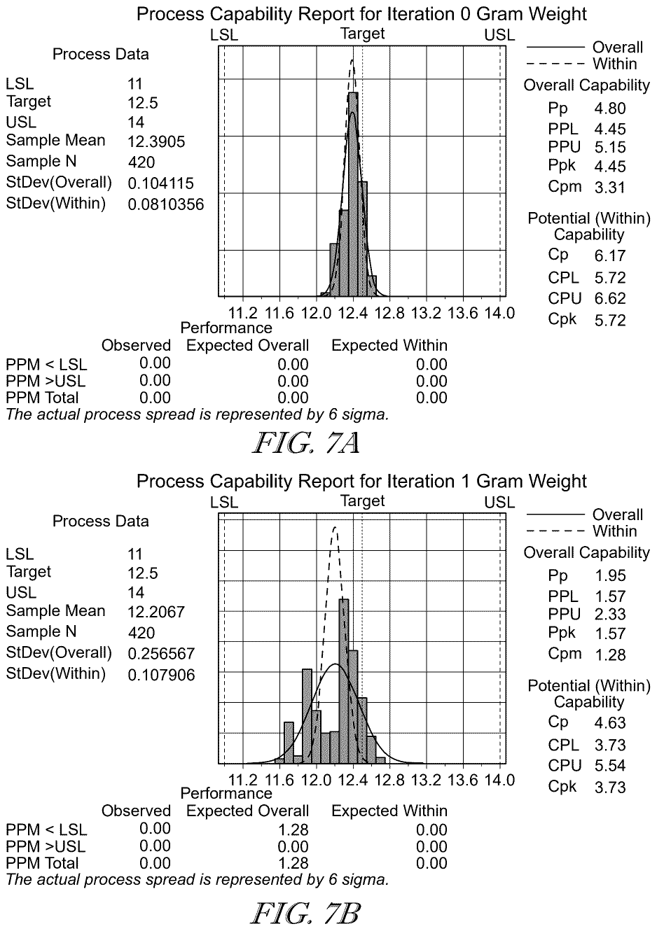

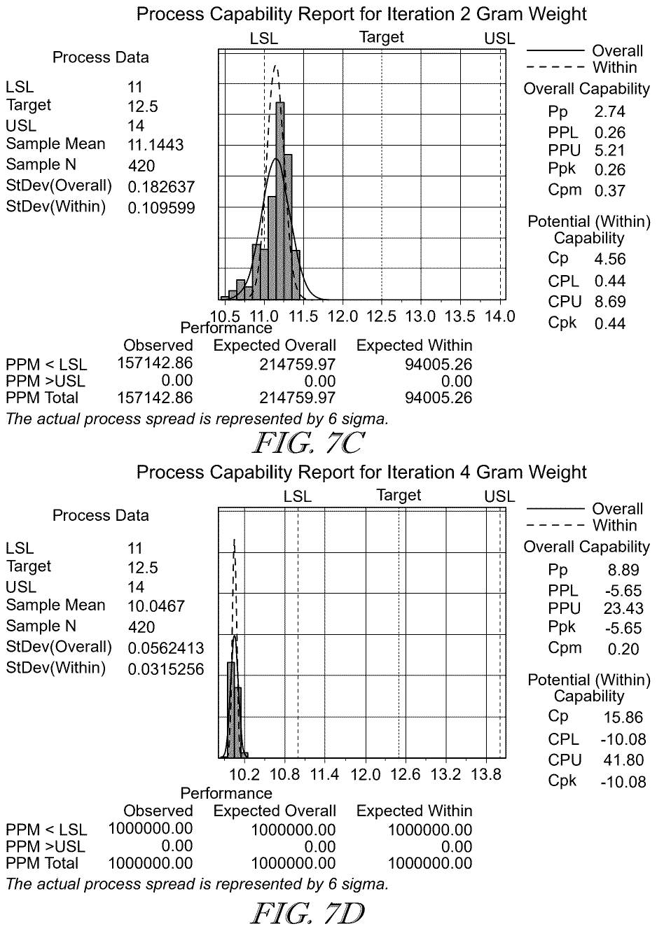

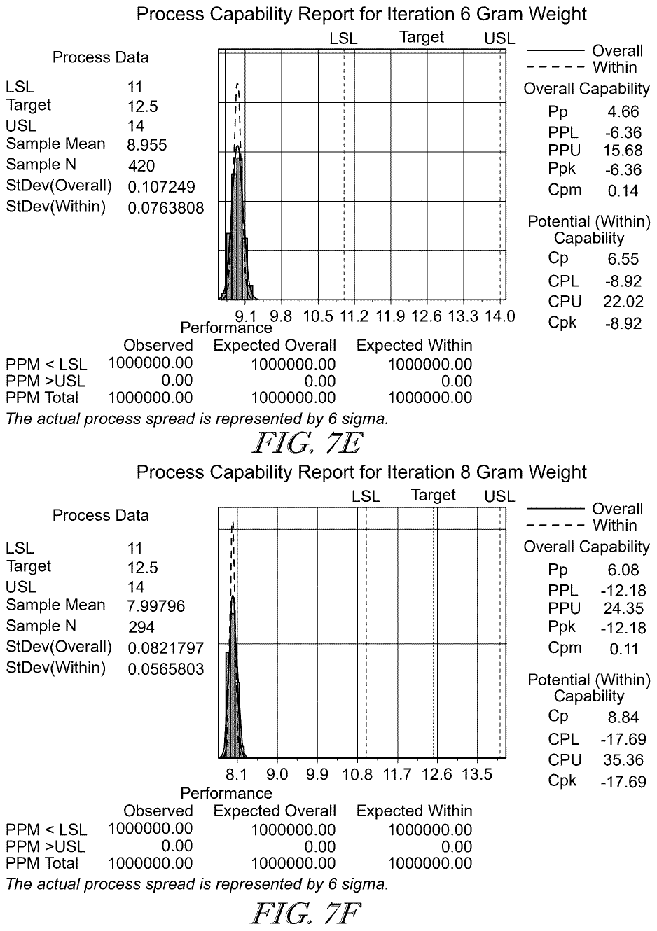

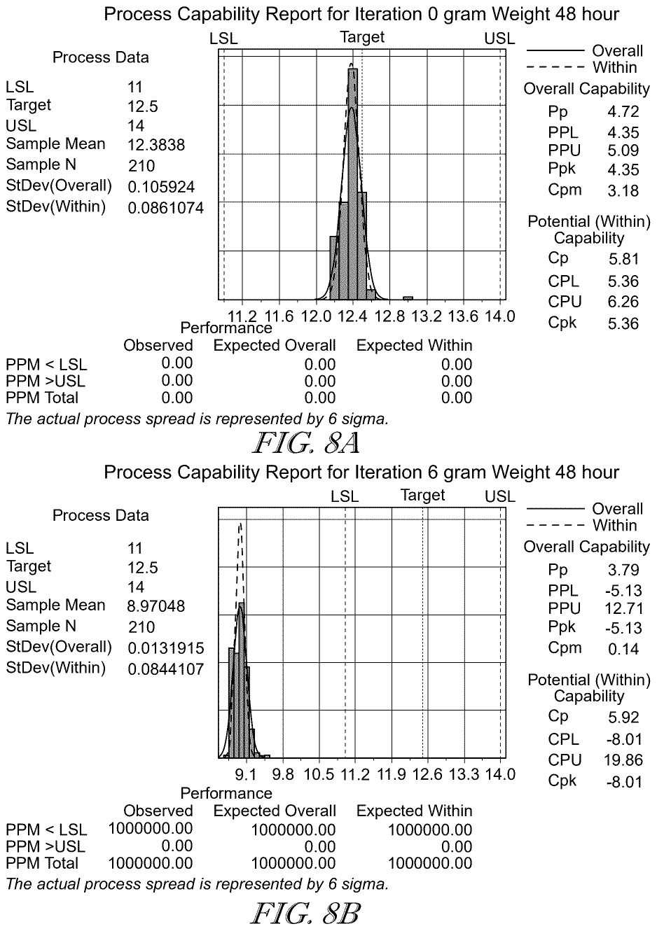

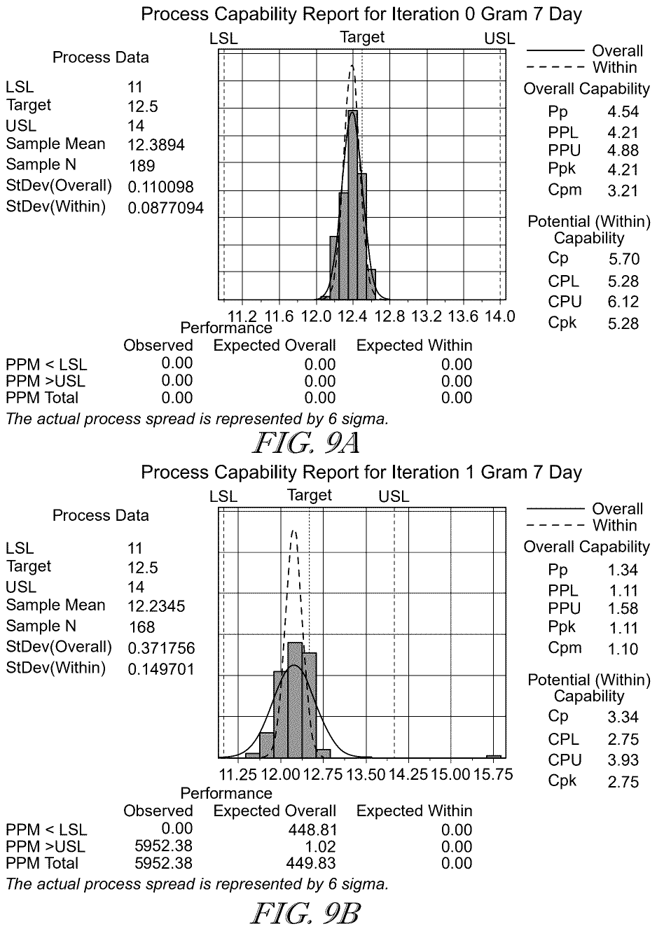

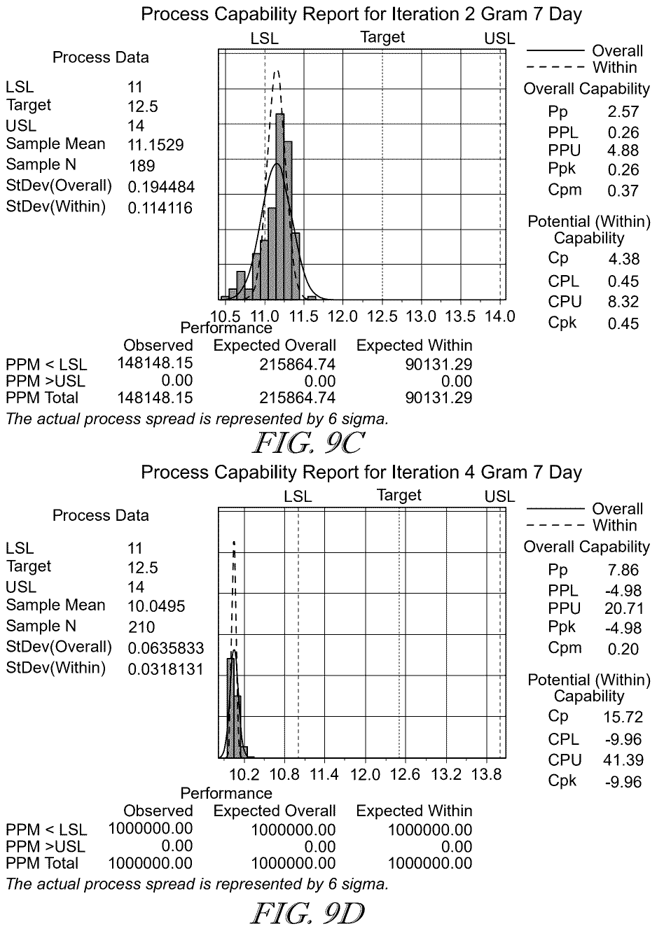

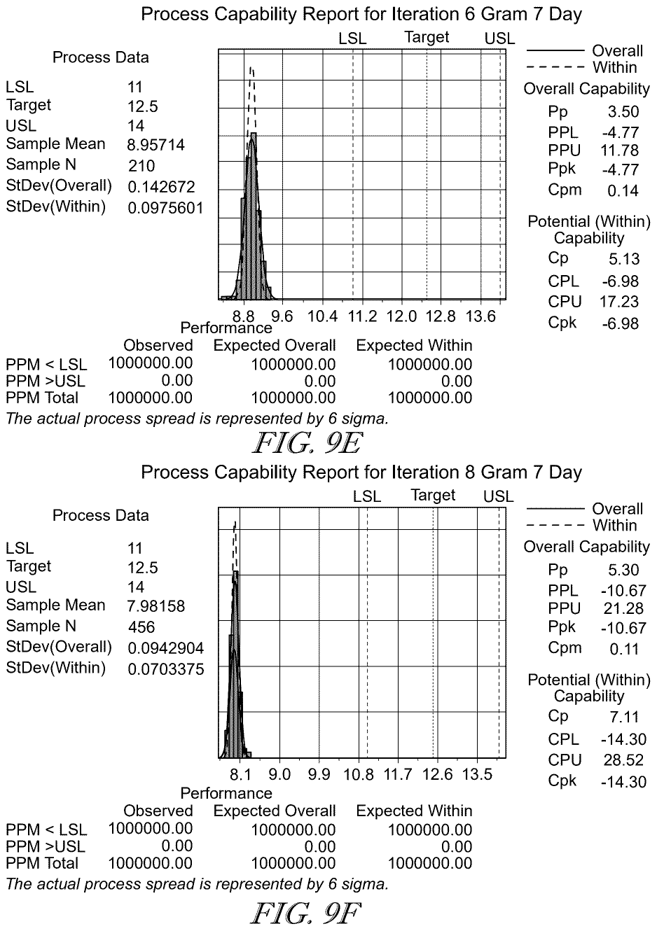

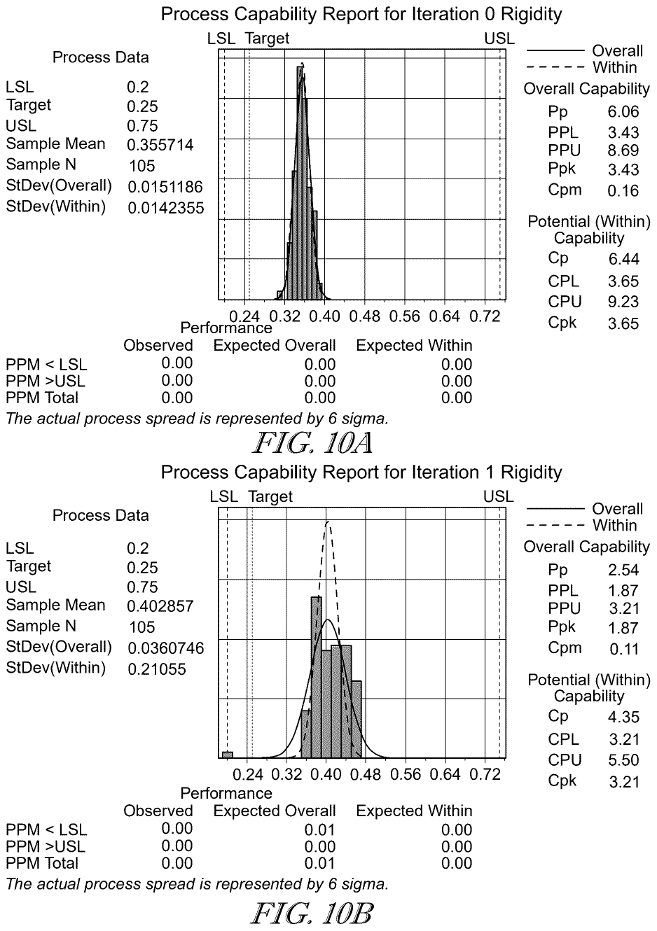

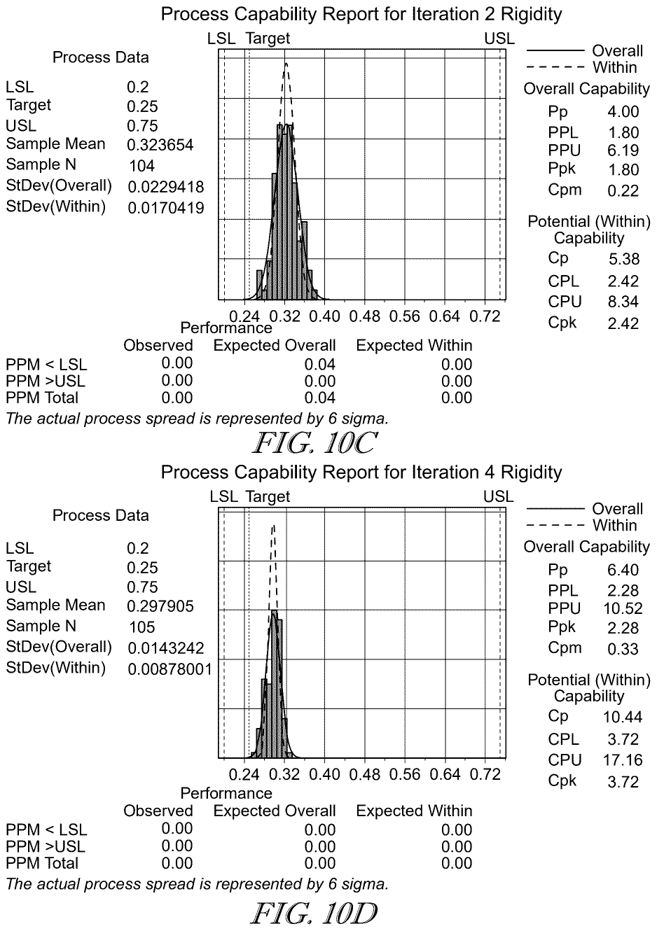

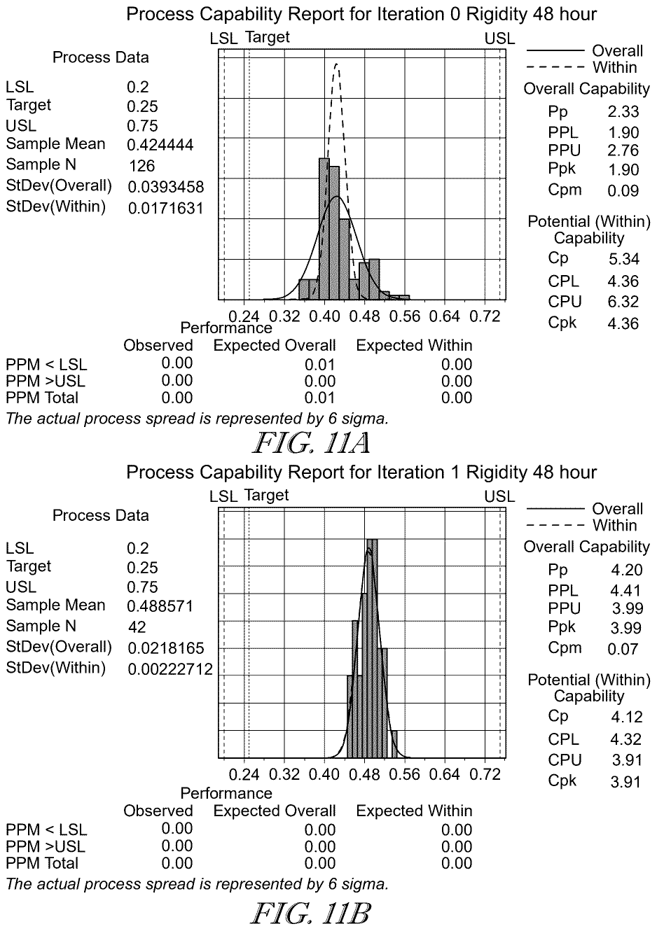

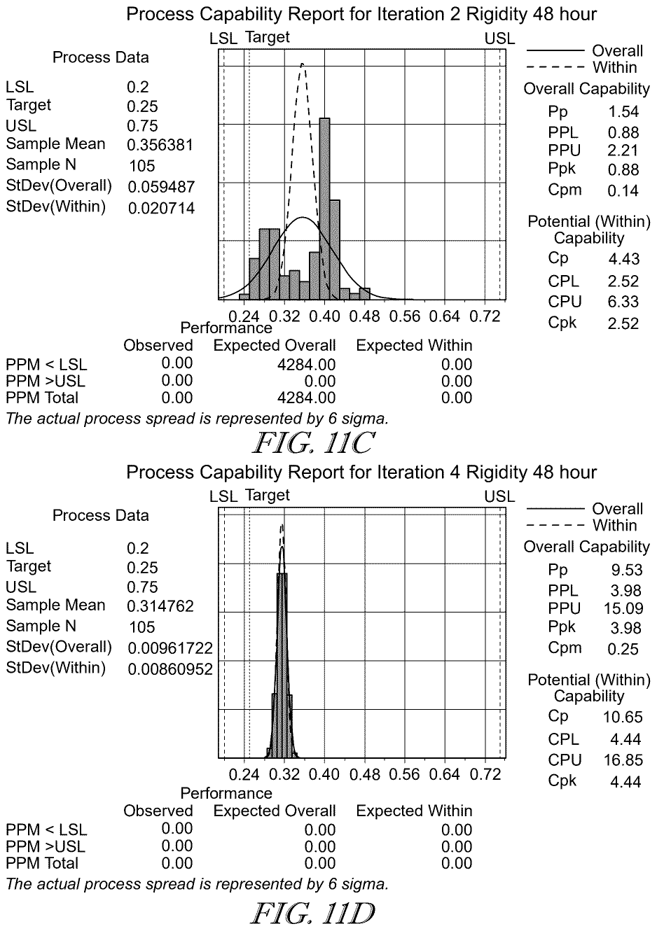

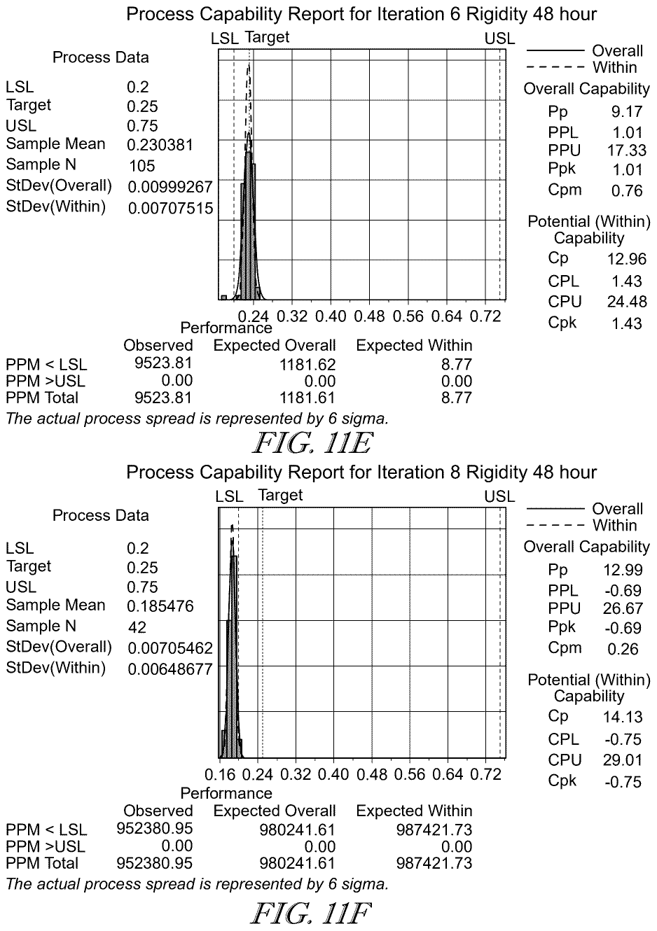

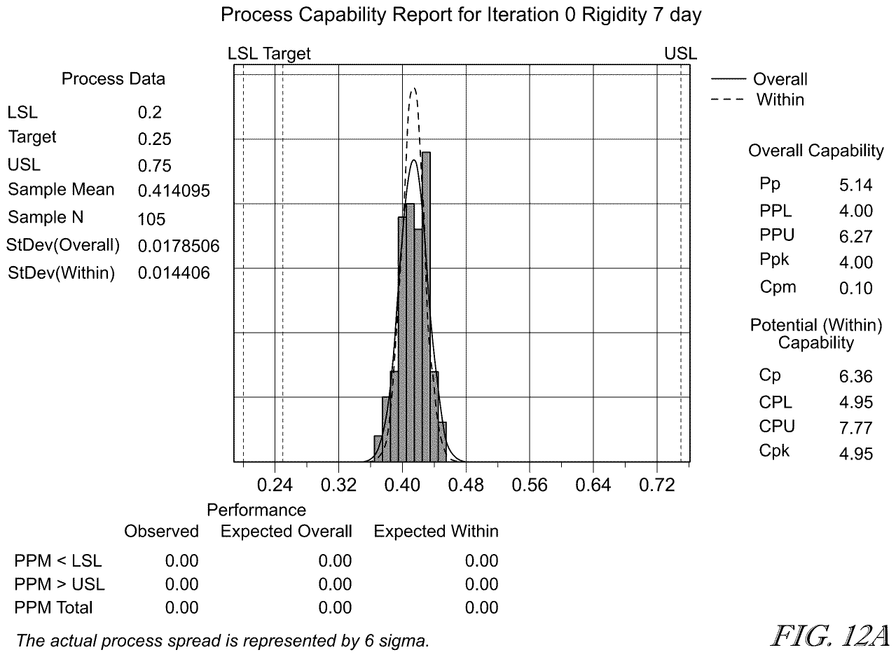

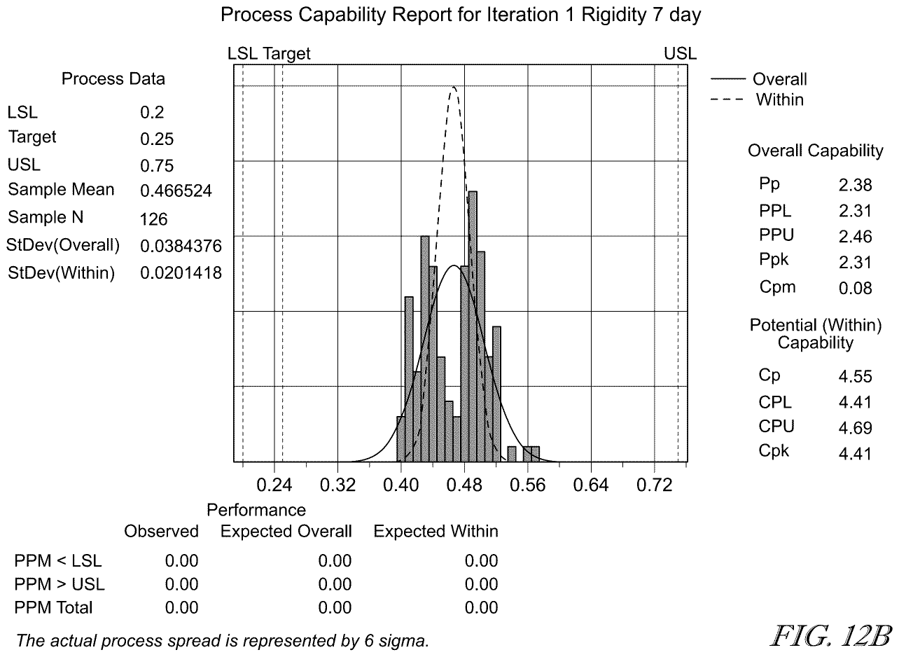

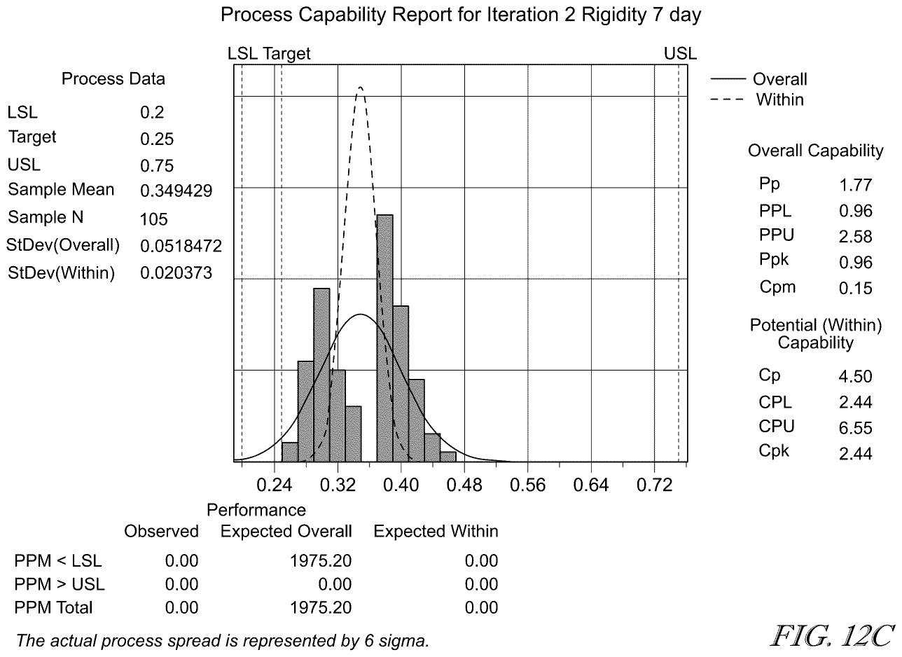

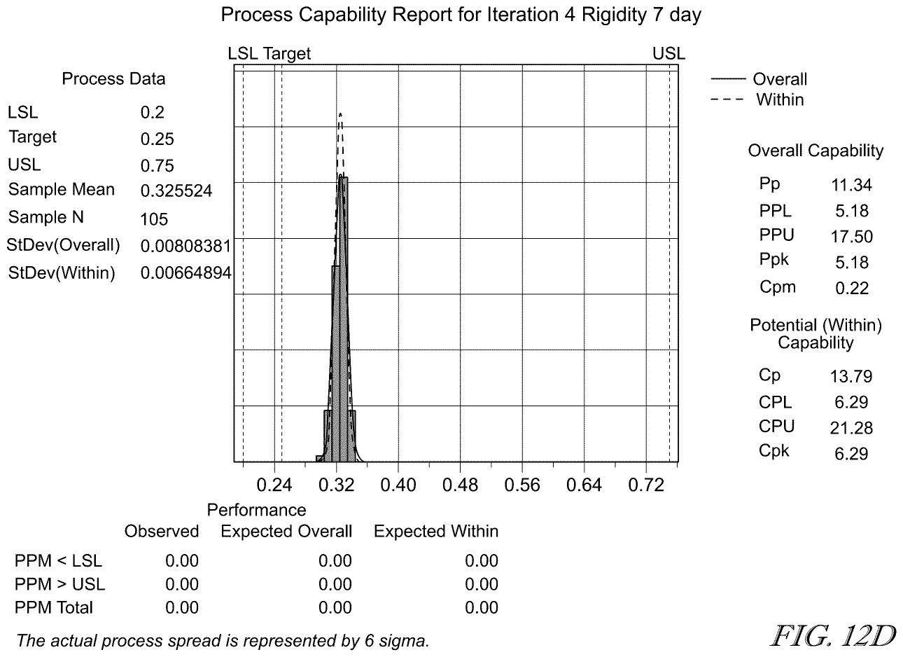

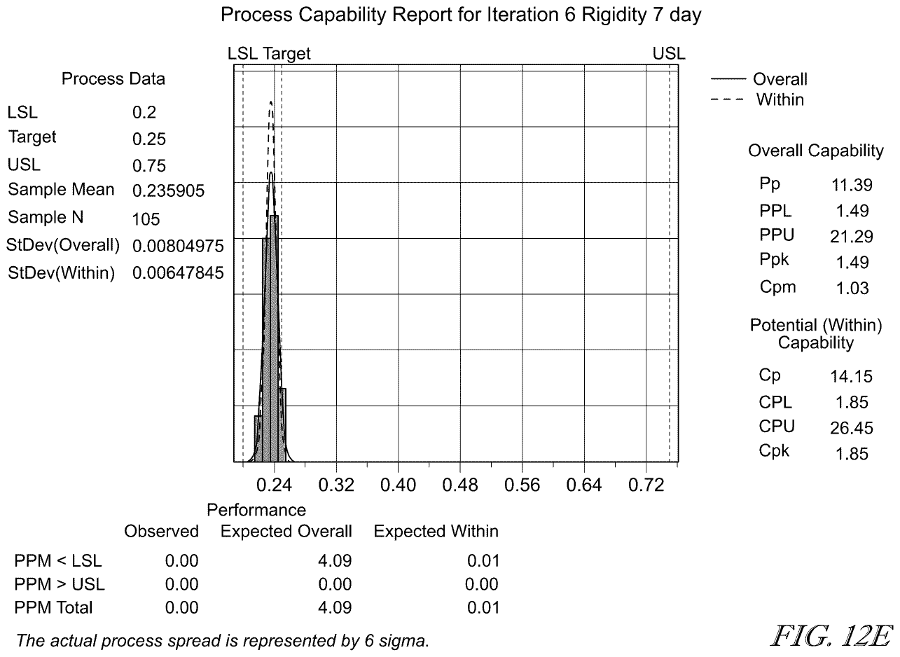

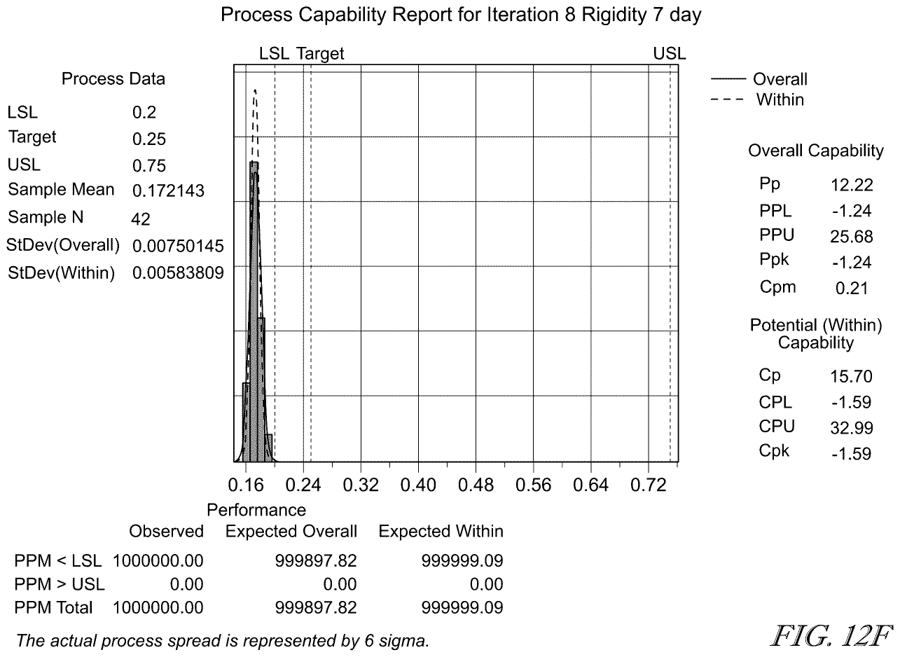

As shown in Table #26 below, different iterations were performed with varying target gram weights. The polymer formulation included 1% of beta nucleating agent. FIGS. 7A-7F, 8A-8B, 9A-9F illustrate the gram weight at the time of running the production, 48 hours after the production, and 7 days after the production for the various target weights. FIGS. 10A-10D, 11A-11F, 12A-12F illustrate the rigidity at the time of running the production, 48 hours after the production, and 7 days after the production for the various target weights.

TABLE 26

| | | Gram | % Reduction | |
|---|---|---|---|---|
| | | Weight | from | Sheet |
| [symbol] | Material | Target | Baseline | Gauge |
| [symbol] | Standard PP | 12.5 | 0% | 0.089″ |
| [symbol] on 1 | Superfly w/1% MPM-2000 | 12.5 | 0% | 0.089″ |
| [symbol] on 2 | Superfly w/1% MPM-2000 | 11.5 | 8% | 0.082″ |
| [symbol] on 3 | Superfly w/1% MPM-2000 | 10.5 | 16% | 0.075″ |
| [symbol] on 4 | Superfly w/1% MPM-2000 | 10.0 | 20% | 0.071″ |
| Iteration 5 | Superfly w/1% MPM-2000 | 9.5 | 24% | 0.068″ |
| Iteration 6 | Superfly w/1% MPM-2000 | 9.0 | 28% | 0.064″ |
| Iteration 7 | Superfly w/1% MPM-2000 | 8.5 | 32% | 0.061″ |
| Iteration 8 | Superfly w/1% MPM-2000 | 8.0 | 36% | 0.057″ |

[symbol]

indicates data missing or illegible when filed

### Example 27: Microcellular Structure

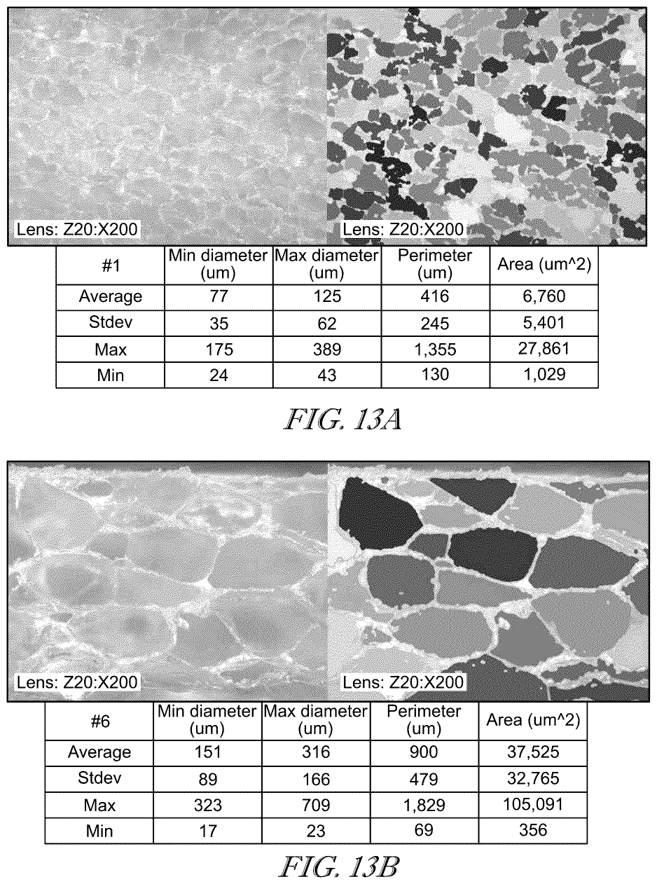

As shown in FIGS. 13A-13B, the cell count in polymer sheets made with the polymer formulations disclosed (FIG. 13A) was higher than the cell count in the comparative sheets used to make containers (FIG. 13B). The polymer formulations used to make sheets disclosed in FIG. 13A included a beta nucleating agent while the polymer formulations used to make sheets disclosed in FIG. 13B did not include any beta nucleating agent.

### Example 28: Decreased Density

As shown in Table #27, use of beta nucleating agents (S. Fly) can decrease the density of the polymer sheet. In some embodiments, the beta nucleating agent (S. Fly) is used in the outer non-foamed or cap layers and the foam-cell nucleating agent (procell) is used in the core or foamed layer.

TABLE 27

| | | 3.3 | 3.5 | | | 3.0 | 6.3 |
|---|---|---|---|---|---|---|---|
| | | Dairy RD Core | Dary RD Core | 5.1B | | Dairy RD Core | Dairy RD Core |
| | 2.1 | Beta nucleating | Bets nucleating | Beta nucleating | 7.0 | Beta nucleating | Beta nucleating |
| | Dairy RD | agent Cap | agent Cap | agent | 6025 + Borealis | agent Cap | agent Cap |
| Cap Layer | [symbol] | [symbol] | [symbol] | [symbol] | — | [symbol] | [symbol] |
| Core | SC204, 6023N, | SC204, 6023N, | SC204, [symbol] | [symbol] | [symbol] | SC204, 6023N, | 6025 [symbol] |
| | [symbol] | [symbol] | | | | [symbol] | |
| Density Reduction | 29% | 28.7% | 25% | 33% | 26% | <5% | <5% |
| Output (kg/h) | 37.3 | 56.3 | 56.3 | 56.2 | 58.3 | 37.2 | 37.2 |
| Viscosity (Pa s) | 1521 | 1416 | 1404 | 1467 | 2383 | 2282 | 1757 |
| Shear Rate (s − 1) | 13.9 | 21 | 20.9 | 20.9 | 20.6 | 13.7 | 13.9 |
| Die Lip Gap (mm) | 0.7 | 1.1 | 1.1 | 1.1 | 1.1 | 0.7 | 0.7 |
| Pump Exit Pressure | 96 | 114 | 113 | 114 | 142 | 112 | — |
| (bar) (core extruder) | | | | | | | |
| Core Extruder Melt | 233 | 234 | 233 | 234 | 201 | 208 | — |
| Temp (° C.) | | | | | | | |
| Roll Stand Top - | 55-65-65 | 95-95-95 | 90-95-95 | 95-95-95 | 55-55-55 | 55-65-75 | — |
| Middle - Bottom (° C.) | | | | | | | |

[symbol]

indicates data missing or illegible when filed

1. A polymer sheet comprising:
a foamed layer comprising a first formulation, and
a first non-foamed layer positioned adjacent to a first surface of the foamed layer,
wherein the first non-foamed layer comprises a second formulation including a beta nucleating agent.

2. The polymer sheet of claim 1, wherein the first formulation includes about 5% of a high melt strength polymer.

3. The polymer sheet of claim 1, wherein the first formulation includes about 10% of a high melt strength polymer.

4. The polymer sheet of claim 1, further comprising a second non-foamed layer positioned adjacent to a second surface of the foamed layer.

5. The polymer sheet of claim 4, wherein the second non-foamed layer comprises a third formulation including the beta nucleating agent.

6. The polymer sheet of claim 4, wherein the second non-foamed layer comprises the second formulation.

7. The polymer sheet of the claim 1, wherein the first formulation does not comprise a colorant.

8. The polymer sheet of the claim 1, wherein the second formulation does not comprise a colorant.

9. The polymer sheet of claim 1, wherein the first formulation includes hot regrind.

10. A thermoformed container made from the sheet of claim 1.

11. The polymer sheet of claim 1, wherein the first formulation further comprises an additive.

12. The polymer sheet of claim 1, wherein the second formulation further comprises an additive.

13. The polymer sheet of claim 1, wherein the second formulation comprises about 2 wt % of the beta nucleating agent.

14. The polymer sheet of claim 1, wherein the first formulation comprises a foam nucleating agent.

15. The polymer sheet of claim 1, wherein the polymer sheet has a lower density than a density of a polymer used in the first formulation or the second formulation.

16. The polymer sheet of claim 1, wherein the polymer sheet comprises more than three layers.

17. The polymer sheet of claim 1, wherein the polymer sheet is colored white due to presence of microvoids.

18. A container comprising:
a foamed layer comprising a first formulation, and
a first non-foamed layer positioned adjacent to a first surface of the foamed layer,
wherein the first non-foamed layer comprises a second formulation including a beta nucleating agent.

19. The container of claim 1, wherein the first formulation includes about 5% of a high melt strength polymer.

20. The container of claim 1, further comprising a second non-foamed layer positioned adjacent to a second surface of the foamed layer.
